(19) United States
(12) Patent Application Publication
(10) Pub. No.: US 2024/0414577 A1
(43) Pub. Date: Dec. 12, 2024

(54) CROSS-LINK INTERFERENCE REPORTING FOR MULTIPLE TYPES OF TRANSMISSION TIME INTERVALS

(71) Applicant: QUALCOMM Incorporated, San Diego, CA (US)

(72) Inventors: Qian ZHANG, Basking Ridge, NJ (US); Yan ZHOU, San Diego, CA (US)

(21) Appl. No.: 18/332,482

(22) Filed: Jun. 9, 2023

(51) Int. Cl. H04W 24/10; H04W 72/541

(52) U.S. Cl. CPC H04W 24/10; H04W 72/541

(57) ABSTRACT

Methods, systems, and devices for wireless communication are described. A network entity may receive control information that indicates parameter information for reporting cross-link interference (CLI). The parameter information may include first parameter information associated, in the control information, with a first type of transmission time interval (TTI) or the parameter information may include second parameter information associated, in the control information, with a second type of TTI. The network entity may receive one or more CLI reference signals during one or more TTIs of the first type of TTI or the second type of TTI. The network entity may transmit a report including information indicative of CLI. The information indicative of the CLI may be associated with the one or more CLI reference signals.

### INTRODUCTION

The following relates to wireless communication, including cross-link interference (CLI) reporting for multiple types of transmission time intervals (TTIs).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities, each supporting wireless communication for communication devices, which may be known as user equipment (UE).

### SUMMARY

The described techniques relate to improved methods, systems, devices, and apparatuses that support cross-link interference (CLI) reporting for multiple types of transmission time intervals (TTIs). For example, the described techniques provide a framework for configuring a first network entity with parameters for measuring or reporting CLI that is associated with one or multiple types of TTIs. In some examples, the first network entity may receive control information that indicates parameter information for reporting CLI. The parameter information may include first parameter information associated, in the control information, with a first type of TTI. For example, based on receiving the control information, the first network entity may receive one or more CLI reference signals during one or more TTIs of the first type of TTI. In some examples, the first network entity may transmit a report including information indicative of CLI. In such examples, the information indicative of the CLI may be associated with the one or more CLI reference signals.

A method of wireless communication performed by a first network entity is described. The method may include receiving control information that indicates parameter information for reporting CLI, where the parameter information includes first parameter information for reporting CLI, and where the first parameter information is associated, in the control information, with a first type of TTI, receiving one or more CLI reference signals during one or more TTIs of the first type of TTI, and transmitting a report including information indicative of CLI, where the information indicative of the CLI is associated with the one or more CLI reference signals.

A first network entity for wireless communication is described. The first network entity may include at least one communication interface, and at least one processor coupled to the at least one communication interface. The first network entity may be configured to receive control information that indicates parameter information for reporting CLI, where the parameter information includes first parameter information for reporting CLI, and where the first parameter information is associated, in the control information, with a first type of TTI, receive one or more CLI reference signals during one or more TTIs of the first type of TTI, and transmit a report including information indicative of CLI, where the information indicative of the CLI is associated with the one or more CLI reference signals.

Another first network entity for wireless communication is described. The first network entity may include means for receiving control information that indicates parameter information for reporting CLI, where the parameter information includes first parameter information for reporting CLI, and where the first parameter information is associated, in the control information, with a first type of TTI, means for receiving one or more CLI reference signals during one or more TTIs of the first type of TTI, and means for transmitting a report including information indicative of CLI, where the information indicative of the CLI is associated with the one or more CLI reference signals.

A non-transitory computer-readable medium having code for wireless communication stored thereon is described. The code, when executed by a first network entity, may cause the first network entity to receive control information that indicates parameter information for reporting CLI, where the parameter information includes first parameter information for reporting CLI, and where the first parameter information is associated, in the control information, with a first type of TTI, receive one or more CLI reference signals during one or more TTIs of the first type of TTI, and transmit a report including information indicative of CLI, where the information indicative of the CLI is associated with the one or more CLI reference signals.

In some examples of the method, network entities, and non-transitory computer-readable medium described herein, the parameter information includes second parameter information for reporting CLI, the second parameter information may be associated, in the control information, with a second type of TTI, and the second type of TTI may be different from the first type of TTI.

In some examples of the method, network entities, and non-transitory computer-readable medium described herein, the control information indicates a first set of CLI resources associated with the first type of TTI and a second set of CLI resources associated with the second type of TTI.

In some examples of the method, network entities, and non-transitory computer-readable medium described herein, the one or more CLI reference signals may be received during at least one CLI reference signal of the first set of CLI resources.

In some examples of the method, network entities, and non-transitory computer-readable medium described herein, the information indicative of the CLI may be associated with only the first type of TTI.

Some examples of the method, network entities, and non-transitory computer-readable medium described herein may further include operations, features, means, or instructions for receiving a second one or more CLI reference signals during one or more TTIs of the second type of TTI and transmitting a second report including second information indicative of CLI, where the second information indicative of the CLI may be associated with only the second one or more CLI reference signals.

In some examples of the method, network entities, and non-transitory computer-readable medium described herein, the information indicative of the CLI may be associated with both the first type of TTI and the second type of TTI.

Some examples of the method, network entities, and non-transitory computer-readable medium described herein may further include operations, features, means, or instructions for refraining from averaging CLI measurement values across different TTI types, where the information indicative of the CLI includes first information associated with the first type of TTI and second information associated with the second type of TTI based on the refraining.

In some examples of the method, network entities, and non-transitory computer-readable medium described herein, the first information includes a first CLI measurement value that may be indicated as being associated with the first type of TTI and the second information includes a second CLI measurement value that may be indicated as being associated with the second type of TTI.

In some examples of the method, network entities, and non-transitory computer-readable medium described herein, first CLI measurement value includes a first value of a CLI metric and the second CLI measurement value includes a second value of the CLI metric and the first value may be associated with the first type of TTI and the second value may be associated with the second type of TTI.

In some examples of the method, network entities, and non-transitory computer-readable medium described herein, the first type of TTI includes a sub-band full-duplex (SBFD) TTI type, a non-SBFD TTI type, a misaligned dynamic time division duplex (TDD) TTI type, an aligned dynamic time division duplex (TDD) TTI type, or a non-SBFD misaligned dynamic TDD TTI type.

Some examples of the method, network entities, and non-transitory computer-readable medium described herein may further include operations, features, means, or instructions for generating, based on the one or more CLI reference signals, the information indicative of the CLI.

In some examples of the method, network entities, and non-transitory computer-readable medium described herein, receiving the control information may include operations, features, means, or instructions for receiving the control information via a CLI report configuration message or a CSI report configuration message.

In some examples of the method, network entities, and non-transitory computer-readable medium described herein, the control information indicates a minimum quantity of TTIs between a reporting TTI in which the report may be to be transmitted and a reference TTI and the minimum quantity of TTIs includes TTIs of any type.

In some examples of the method, network entities, and non-transitory computer-readable medium described herein, the control information indicates a minimum quantity of TTIs between a reporting TTI in which the report may be to be transmitted and a reference TTI and the minimum quantity of TTIs includes TTIs of only the first type.

In some examples of the method, network entities, and non-transitory computer-readable medium described herein, the first type of TTI includes a type of slot or a type of symbol.

In some examples of the method, network entities, and non-transitory computer-readable medium described herein, the first network entity includes a user equipment (UE), the one or more CLI reference signals include UE-to-UE CLI reference signals, and the information indicative of CLI includes information indicative of UE-to-UE CLI.

In some examples of the method, network entities, and non-transitory computer-readable medium described herein, the first parameter information may be for reporting CLI that may be associated with a half-duplex operation mode at the first network entity.

In some examples of the method, network entities, and non-transitory computer-readable medium described herein, receiving the control information may include operations, features, means, or instructions for receiving the control information from a second network entity, where the first parameter information may be for reporting CLI that may be associated with a full-duplex operation mode at the second network entity.

In some examples of the method, network entities, and non-transitory computer-readable medium described herein, receiving the control information may include operations, features, means, or instructions for receiving the control information from a second network entity, where the first parameter information may be for reporting CLI that may be associated with a SBFD operation mode at the second network entity.

In some examples of the method, network entities, and non-transitory computer-readable medium described herein, receiving the control information may include operations, features, means, or instructions for receiving the control information from a second network entity, where the first parameter information may be for reporting CLI that may be associated with a half-duplex operation mode at the second network entity and with a misaligned TTI format.

In some examples of the method, network entities, and non-transitory computer-readable medium described herein, the parameter information includes information indicative of at least one parameter for measuring or reporting CLI.

In some examples of the method, network entities, and non-transitory computer-readable medium described herein, the at least one parameter includes a type of CLI metric to be reported, one or more resources for measuring CLI, or one or more resources for reporting CLI.

In some examples of the method, network entities and non-transitory computer-readable medium described herein, the type of CLI metric includes a reference signal received power (RSRP) metric type or a received signal strength indicator (RSSI) metric type.

In some examples of the method, network entities, and non-transitory computer-readable medium described herein, the control information includes an indication that the first parameter information may be applicable to TTIs of the first type of TTI.

A method of wireless communication performed by a first network entity is described. The method may include receiving control information that indicates resource allocation information for measuring CLI, receiving one or more CLI reference signals via one or more CLI resources in accordance with the resource allocation information, where the one or more CLI resources are within one or more sub-bands of a set of non-contiguous sub-bands allocated for downlink communication, and transmitting a report including information indicative of CLI, where the information indicative of the CLI is associated with the one or more CLI reference signals.

A first network entity for wireless communication is described. The first network entity may include at least one communication interface, and at least one processor coupled to the at least one communication interface. The first network entity may be configured to receive control information that indicates resource allocation information for measuring CLI, receive one or more CLI reference signals via one or more CLI resources in accordance with the resource allocation information, where the one or more CLI resources are within one or more sub-bands of a set of non-contiguous sub-bands allocated for downlink communication, and transmit a report including information indicative of CLI, where the information indicative of the CLI is associated with the one or more CLI reference signals.

Another first network entity for wireless communication is described. The first network entity may include means for receiving control information that indicates resource allocation information for measuring CLI, means for receiving one or more CLI reference signals via one or more CLI resources in accordance with the resource allocation information, where the one or more CLI resources are within one or more sub-bands of a set of non-contiguous sub-bands allocated for downlink communication, and means for transmitting a report including information indicative of CLI, where the information indicative of the CLI is associated with the one or more CLI reference signals.

A non-transitory computer-readable medium having code for wireless communication stored thereon is described. The code, when executed by a first network entity, may cause the first network entity to receive control information that indicates resource allocation information for measuring CLI, receive one or more CLI reference signals via one or more CLI resources in accordance with the resource allocation information, where the one or more CLI resources are within one or more sub-bands of a set of non-contiguous sub-bands allocated for downlink communication, and transmit a report including information indicative of CLI, where the information indicative of the CLI is associated with the one or more CLI reference signals.

In some examples of the method, network entities, and non-transitory computer-readable medium described herein, the one or more CLI resources includes a CLI resource that may be within one sub-band of the set of non-contiguous sub-bands allocated for downlink communication.

In some examples of the method, network entities, and non-transitory computer-readable medium described herein, the one or more CLI resources includes two CLI resources and each CLI resource of the two CLI resources may be within a respective sub-band of the set of non-contiguous sub-bands allocated for downlink communication.

In some examples of the method, network entities, and non-transitory computer-readable medium described herein, the one or more CLI resources includes a CLI resource that may be within at least two sub-bands of the set of non-contiguous sub-bands allocated for downlink communication.

In some examples of the method, network entities, and non-transitory computer-readable medium described herein, the resource allocation information includes a bitmap that indicates a distribution of the CLI resource across the set of non-contiguous sub-bands.

In some examples of the method, network entities, and non-transitory computer-readable medium described herein, the resource allocation information indicates a set of multiple resource block sets that include the CLI resource and each resource block set of the set of multiple resource block sets may be associated with a respective sub-band of the set of non-contiguous sub-bands allocated for downlink communication.

In some examples of the method, network entities, and non-transitory computer-readable medium described herein, the one or more CLI resources include a CLI resource that may be within the set of non-contiguous sub-bands allocated for downlink communication and the method, network entities, and non-transitory computer-readable medium may include further operations, features, means, or instructions for measuring CLI within a portion of the CLI resource, where the portion may be based on semi-static configuration information for SBFD operations, where the semi-static configuration information may be for a sub-band allocated for uplink communications and one or more sub-bands of the set of non-contiguous sub-bands allocated for downlink communication or the semi-static configuration information may be for the sub-band allocated for uplink communications and one or more guard bands, and where the information may be indicative of the measured CLI.

Some examples of the method, network entities, and non-transitory computer-readable medium described herein may further include operations, features, means, or instructions for receiving second control information that indicates a frequency location of the sub-band allocated for uplink communication or a respective frequency location of the one or more guard bands.

In some examples of the method, network entities, and non-transitory computer-readable medium described herein, the resource allocation information indicates two CLI resource sets that include the one or more CLI resources and each CLI resource set of the two CLI resource sets may be associated with a respective sub-band of the set of non-contiguous sub-bands allocated for downlink communication.

In some examples of the method, network entities, and non-transitory computer-readable medium described herein, the resource allocation information indicates a CLI resource set that includes the one or more CLI resources and the CLI resource set may be associated with the set of non-contiguous sub-bands allocated for downlink communication.

In some examples of the method, network entities, and non-transitory computer-readable medium described herein, the resource allocation information includes a bitmap that indicates the one or more CLI resources.

In some examples of the method, network entities, and non-transitory computer-readable medium described herein, the resource allocation information indicates one or more resource block sets within the CLI resource set, the one or more resource block sets include the one or more CLI resources, and each resource block set may be associated with a respective sub-band of the set of non-contiguous sub-bands allocated for downlink communication.

Some examples of the method, network entities, and non-transitory computer-readable medium described herein may further include operations, features, means, or instructions for measuring CLI within one or more resource block sets within the CLI resource set, where the one or more resource block sets include the one or more CLI resources, where the one or more resource block sets may be based on semi-static configuration information for SBFD operations, where the semi-static configuration information may be for a sub-band allocated for uplink communications and one or more sub-bands of the set of non-contiguous sub-bands allocated for downlink communication or the semi-static configuration information may be for the sub-band allocated for uplink communications and one or more guard bands, and where the information may be indicative of the measured CLI.

In some examples of the method, network entities, and non-transitory computer-readable medium described herein, the set of non-contiguous sub-bands allocated for downlink communication may be within a TTI allocated for SBFD operations at a second network entity.

In some examples of the method, network entities, and non-transitory computer-readable medium described herein, the first network entity includes a UE and the second network entity includes a base station.

In some examples of the method, network entities, and non-transitory computer-readable medium described herein, the one or more CLI reference signals include UE-to-UE CLI reference signals and the resource allocation information may be for measuring UE-to-UE CLI.

In some examples of the method, network entities, and non-transitory computer-readable medium described herein, the resource allocation information may be for measuring CLI that may be associated with a half-duplex operation mode at the first network entity.

In some examples of the method, network entities, and non-transitory computer-readable medium described herein, receiving the control information may include operations, features, means, or instructions for receiving the control information from a second network entity, where the resource allocation information may be for measuring CLI that may be associated with a full-duplex operation mode at the second network entity.

In some examples of the method, network entities, and non-transitory computer-readable medium described herein, receiving the control information may include operations, features, means, or instructions for receiving the control information from a second network entity, where the resource allocation information may be for measuring CLI that may be associated with a SBFD operation mode at the second network entity.

In some examples of the method, network entities, and non-transitory computer-readable medium described herein, receiving the control information may include operations, features, means, or instructions for receiving the control information from a second network entity, where the resource allocation information may be for measuring CLI that may be associated with a half-duplex operation mode at the second network entity and with a misaligned TTI format.

A method of wireless communication performed by a first network entity is described. The method may include outputting control information that indicates parameter information for reporting CLI, where the parameter information includes first parameter information for reporting CLI, and where the first parameter information is associated, in the control information, with a first type of TTI and obtaining a report including information indicative of CLI, where the information indicative of the CLI is associated with one or more CLI resources that are within one or more TTIs of the first type of TTI.

A first network entity for wireless communication is described. The first network entity may include at least one communication interface, and at least one processor coupled to the at least one communication interface. The first network entity may be configured to output control information that indicate parameter information for reporting CLI, where the parameter information includes first parameter information for reporting CLI, and where the first parameter information is associated, in the control information, with a first type of TTI and obtain a report including information indicative of CLI, where the information indicative of the CLI is associated with one or more CLI resources that are within one or more TTIs of the first type of TTI.

Another first network entity for wireless communication is described. The first network entity may include means for outputting control information that indicates parameter information for reporting CLI, where the parameter information includes first parameter information for reporting CLI, and where the first parameter information is associated, in the control information, with a first type of TTI and means for obtaining a report including information indicative of CLI, where the information indicative of the CLI is associated with one or more CLI resources that are within one or more TTIs of the first type of TTI.

A non-transitory computer-readable medium having code for wireless communication stored thereon is described. The code, when executed by a first network entity, may cause the first network entity to output control information that indicate parameter information for reporting CLI, where the parameter information includes first parameter information for reporting CLI, and where the first parameter information is associated, in the control information, with a first type of TTI and obtain a report including information indicative of CLI, where the information indicative of the CLI is associated with one or more CLI resources that are within one or more TTIs of the first type of TTI.

In some examples of the method, network entities, and non-transitory computer-readable medium described herein, the parameter information includes second parameter information for reporting CLI, the second parameter information may be associated, in the control information, with a second type of TTI, and the second type of TTI may be different from the first type of TTI.

In some examples of the method, network entities, and non-transitory computer-readable medium described herein, the control information indicates a first set of CLI resources associated with the first type of TTI and a second set of CLI resources associated with the second type of TTI.

In some examples of the method, network entities, and non-transitory computer-readable medium described herein, the first set of CLI resources includes the one or more CLI resources.

In some examples of the method, network entities, and non-transitory computer-readable medium described herein, the information indicative of the CLI may be associated with only the first type of TTI.

Some examples of the method, network entities, and non-transitory computer-readable medium described herein may further include operations, features, means, or instructions for obtaining a second report including second information indicative of CLI, where the second information indicative of the CLI may be associated with only a second one or more CLI resources that may be within one or more TTIs of the second type of TTI.

In some examples of the method, network entities, and non-transitory computer-readable medium described herein, the information indicative of the CLI may be associated with both the first type of TTI and the second type of TTI.

In some examples of the method, network entities, and non-transitory computer-readable medium described herein, the information indicative of the CLI includes first information associated with the first type of TTI and second information associated with the second type of TTI.

In some examples of the method, network entities, and non-transitory computer-readable medium described herein, the first information includes a first CLI measurement value that may be indicated as being associated with the first type of TTI and the second information includes a second CLI measurement value that may be indicated as being associated with the second type of TTI.

In some examples of the method, network entities, and non-transitory computer-readable medium described herein, first CLI measurement value includes a first value of a CLI metric and the second CLI measurement value includes a second value of the CLI metric and the first value may be associated with the first type of TTI and the second value may be associated with the second type of TTI.

In some examples of the method, network entities, and non-transitory computer-readable medium described herein, the first type of TTI includes a SBFD TTI type, a non-SBFD TTI type, a misaligned dynamic TDD TTI type, an aligned dynamic TDD TTI type, or a non-SBFD misaligned dynamic TDD TTI type.

In some examples of the method, network entities, and non-transitory computer-readable medium described herein, the first type of TTI includes a type of slot or a type of symbol.

In some examples of the method, network entities, and non-transitory computer-readable medium described herein, outputting the control information may include operations, features, means, or instructions for outputting the control information via a CLI report configuration message or a CSI report configuration message.

In some examples of the method, network entities, and non-transitory computer-readable medium described herein, the control information indicates a minimum quantity of TTIs between a reporting TTI in which the report may be to be transmitted and a reference TTI and the minimum quantity of TTIs includes TTIs of any type.

In some examples of the method, network entities, and non-transitory computer-readable medium described herein, the control information indicates a minimum quantity of TTIs between a reporting TTI in which the report may be to be transmitted and a reference TTI and the minimum quantity of TTIs includes TTIs of only the first type.

In some examples of the method, network entities, and non-transitory computer-readable medium described herein, the first type of TTI includes a type of slot or a type of symbol.

In some examples of the method, network entities, and non-transitory computer-readable medium described herein, the information indicative of CLI includes information indicative of UE-to-UE CLI.

In some examples of the method, network entities, and non-transitory computer-readable medium described herein, outputting the control information may include operations, features, means, or instructions for outputting the control information to a second network entity, where the first parameter information may be for reporting CLI that may be associated with a half-duplex operation mode at the second network entity.

In some examples of the method, network entities, and non-transitory computer-readable medium described herein, the first parameter information may be for reporting CLI that may be associated with a full-duplex operation mode at the first network entity.

In some examples of the method, network entities, and non-transitory computer-readable medium described herein, the first parameter information may be for reporting CLI that may be associated with a SBFD operation mode at the first network entity.

In some examples of the method, network entities, and non-transitory computer-readable medium described herein, the first parameter information may be for reporting CLI that may be associated with a half-duplex operation mode at the first network entity and with a misaligned TTI format.

In some examples of the method, network entities, and non-transitory computer-readable medium described herein, outputting the control information may include operations, features, means, or instructions for outputting the control information to a second network entity, where the first parameter information may be indicative of at least one parameter for measuring or reporting CLI.

In some examples of the method, network entities, and non-transitory computer-readable medium described herein, the at least one parameter includes a type of CLI metric to be reported, one or more resources for measuring CLI, or one or more resources for reporting CLI.

In some examples of the method, network entities, and non-transitory computer-readable medium described herein, the type of CLI metric includes a RSRP metric type or a RSSI metric type.

In some examples of the method, network entities, and non-transitory computer-readable medium described herein, the control information includes an indication that the first parameter information may be applicable to TTIs of the first type of TTI.

A method of wireless communication performed by a first network entity is described. The method may include outputting control information that indicates resource allocation information for measuring CLI and obtaining a report including information indicative of CLI, where the information indicative of the CLI is associated within one or more CLI resources in accordance with the resource allocation information, and where the one or more CLI resources are within one or more sub-bands of a set of non-contiguous sub-bands allocated for downlink communication.

A first network entity for wireless communication is described. The first network entity may include at least one communication interface, and at least one processor coupled to the at least one communication interface. The first network entity may be configured to output control information that indicate resource allocation information for measuring CLI and obtain a report including information indicative of CLI, where the information indicative of the CLI is associated within one or more CLI resources in accordance with the resource allocation information, and where the one or more CLI resources are within one or more sub-bands of a set of non-contiguous sub-bands allocated for downlink communication.

Another first network entity for wireless communication is described. The first network entity may include means for outputting control information that indicates resource allocation information for measuring CLI and means for obtaining a report including information indicative of CLI, where the information indicative of the CLI is associated within one or more CLI resources in accordance with the resource allocation information, and where the one or more CLI resources are within one or more sub-bands of a set of non-contiguous sub-bands allocated for downlink communication.

A non-transitory computer-readable medium having code for wireless communication stored thereon is described. The code, when executed by a first network entity, may cause the first network entity to output control information that indicate resource allocation information for measuring CLI and obtain a report including information indicative of CLI, where the information indicative of the CLI is associated within one or more CLI resources in accordance with the resource allocation information, and where the one or more CLI resources are within one or more sub-bands of a set of non-contiguous sub-bands allocated for downlink communication.

In some examples of the method, network entities, and non-transitory computer-readable medium described herein, the one or more CLI resources includes a CLI resource that may be within one sub-band of the set of non-contiguous sub-bands allocated for downlink communication.

In some examples of the method, network entities, and non-transitory computer-readable medium described herein, the one or more CLI resources includes two CLI resources and each CLI resource of the two CLI resources may be within a respective sub-band of the set of non-contiguous sub-bands allocated for downlink communication.

In some examples of the method, network entities, and non-transitory computer-readable medium described herein, the one or more CLI resources includes a CLI resource that may be within at least two sub-bands of the set of non-contiguous sub-bands allocated for downlink communication.

In some examples of the method, network entities, and non-transitory computer-readable medium described herein, the resource allocation information includes a bitmap that indicates a distribution of the CLI resource across the set of non-contiguous sub-bands.

In some examples of the method, network entities, and non-transitory computer-readable medium described herein, the resource allocation information indicates a set of multiple resource block sets that include the CLI resource and each resource block set of the set of multiple resource block sets may be associated with a respective sub-band of the set of non-contiguous sub-bands allocated for downlink communication.

In some examples of the method, network entities, and non-transitory computer-readable medium described herein, the one or more CLI resources include a CLI resource that may be within the set of non-contiguous sub-bands allocated for downlink communication, the information may be indicative of CLI measured within a portion of the CLI resource that may be based on semi-static configuration information for SBFD operations, and the semi-static configuration information may be for a sub-band allocated for uplink communications and one or more sub-bands of the set of non-contiguous sub-bands allocated for downlink communication or the semi-static configuration information may be for the sub-band allocated for uplink communications and one or more guard bands.

In some examples of the method, network entities, and non-transitory computer-readable medium described herein, outputting second control information that indicates a frequency location of the sub-band allocated for uplink communication or a respective frequency location of the one or more guard bands.

In some examples of the method, network entities, and non-transitory computer-readable medium described herein, the resource allocation information indicates two CLI resource sets that include the one or more CLI resources and each CLI resource set of the two CLI resource sets may be associated with a respective sub-band of the set of non-contiguous sub-bands allocated for downlink communication.

In some examples of the method, network entities, and non-transitory computer-readable medium described herein, the resource allocation information indicates a CLI resource set that includes the one or more CLI resources and the CLI resource set may be associated with the set of non-contiguous sub-bands allocated for downlink communication.

In some examples of the method, network entities, and non-transitory computer-readable medium described herein, the resource allocation information includes a bitmap that indicates the one or more CLI resources.

In some examples of the method, network entities, and non-transitory computer-readable medium described herein, the resource allocation information indicates one or more resource block sets within the CLI resource set, the one or more resource block sets include the one or more CLI resources, and each resource block set may be associated with a respective sub-band of the set of non-contiguous sub-bands allocated for downlink communication.

In some examples of the method, network entities, and non-transitory computer-readable medium described herein, the information may be indicative of CLI measured within one or more resource block sets within the CLI resource set, the one or more resource block sets include the one or more CLI resources, the one or more resource block sets may be based on semi-static configuration information for SBFD operations, and the semi-static configuration information may be for a sub-band allocated for uplink communications and one or more sub-bands of the set of non-contiguous sub-bands allocated for downlink communication or the semi-static configuration information may be for the sub-band allocated for uplink communications and one or more guard bands.

In some examples of the method, network entities, and non-transitory computer-readable medium described herein, the set of non-contiguous sub-bands allocated for downlink communication may be within a TTI allocated for SBFD operations at the first network entity.

In some examples of the method, network entities, and non-transitory computer-readable medium described herein, the first network entity includes a base station.

In some examples of the method, network entities, and non-transitory computer-readable medium described herein, outputting the control information may include operations, features, means, or instructions for outputting the control information to a second network entity that includes a UE, where the resource allocation information may be for measuring UE-to-UE CLI.

In some examples of the method, network entities, and non-transitory computer-readable medium described herein, outputting the control information may include operations, features, means, or instructions for outputting the control information to a second network entity, where the resource allocation information may be for measuring CLI that may be associated with a half-duplex operation mode at the second network entity.

In some examples of the method, network entities, and non-transitory computer-readable medium described herein, the resource allocation information may be for measuring CLI that may be associated with a full-duplex operation mode at the first network entity.

In some examples of the method, network entities, and non-transitory computer-readable medium described herein, the resource allocation information may be for measuring CLI that may be associated with a SBFD operation mode at the first network entity.

In some examples of the method, network entities, and non-transitory computer-readable medium described herein, the resource allocation information may be for measuring CLI that may be associated with a half-duplex operation mode at the first network entity and with a misaligned TTI format.

### BRIEF DESCRIPTION OF THE DRAWINGS

FIGS. 1 and 2 each show an example of a wireless communications system that supports cross-link interference (CLI) reporting for multiple types of transmission time intervals (TTIs) in accordance with one or more aspects of the present disclosure.

FIG. 3 shows an example of an interference measurement diagram that supports CLI reporting for multiple types of TTIs in accordance with one or more aspects of the present disclosure.

FIG. 4 shows an example of a wireless communications system that supports CLI reporting for multiple types of TTIs in accordance with one or more aspects of the present disclosure.

FIGS. 5 and 6 each shows an example of a process flow that supports CLI reporting for multiple types of TTIs in accordance with one or more aspects of the present disclosure.

FIGS. 7 and 8 show block diagrams of devices that support CLI reporting for multiple types of TTIs in accordance with one or more aspects of the present disclosure.

FIG. 9 shows a block diagram of a communications manager that supports CLI reporting for multiple types of TTIs in accordance with one or more aspects of the present disclosure.

FIG. 10 shows a diagram of a system including a device that supports CLI reporting for multiple types of TTIs in accordance with one or more aspects of the present disclosure.

FIGS. 11 and 12 show block diagrams of devices that support CLI reporting for multiple types of TTIs in accordance with one or more aspects of the present disclosure.

FIG. 13 shows a block diagram of a communications manager that supports CLI reporting for multiple types of TTIs in accordance with one or more aspects of the present disclosure.

FIG. 14 shows a diagram of a system including a device that supports CLI reporting for multiple types of TTIs in accordance with one or more aspects of the present disclosure.

FIGS. 15 through 18 show flowcharts illustrating methods that support CLI reporting for multiple types of TTIs in accordance with one or more aspects of the present disclosure.

### DETAILED DESCRIPTION

Some wireless communications systems may include a communication device, such as a user equipment (ULE) or a network entity, that support wireless communications in accordance with a half-duplex mode or a full-duplex mode, or a combination thereof. For example, in a half-duplex mode, the communication device may either transmit communications or receive communications during a time interval, such as a transmission time interval (TTI), that may span one or more time resources (e.g., symbols, mini-slots, slot). In a full-duplex mode, the communication device may transmit and receive communications simultaneously or concurrently. For example, communications received by the communication device may overlap in the time domain with communications transmitted by the communication device. In other words, TTIs occupied by or allocated for received signals may overlap with TTIs occupied by or allocated for transmitted signals. In some examples, neighboring communication devices (e.g., network entities) may perform full-duplex communications or half-duplex time division duplexing (TDD) concurrently, such that downlink communications received by a first communication device may overlap in time, at least partially, with uplink communications transmitted from a second communication device (e.g., a neighboring communication device).

For example, neighboring network entities may perform dynamic TDD concurrently and, as such, a format of a TTI (e.g., a slot or symbol) may be misaligned across cells served by the neighboring network entities. As such, the first communication may receive a downlink signal from a first network entity (e.g., via a cell served by the first network entity), while the second communication device may simultaneously transmit an uplink signal to a second, neighboring entity (e.g., via another cell served by the second network entity). In some other examples, the first network entity may perform full-duplex operations, such as sub-band full-duplex (SBFD) operations in which the first network entity may simultaneously transmit and receive on a sub-band basis. For example, during a TTI, the first communication device may use a sub-band allocated for downlink to receive a downlink signal from the first network entity, while the second communication device may simultaneously use a sub-band allocated for uplink to transmit the uplink signal to the first network entity. Accordingly, dynamic TDD operations or full-duplex operations, or both, may lead to uplink communications transmitted from the second communication device interfering with downlink communications received at the first communication device. Such interference may be referred to as cross-link interference (CLI). In some examples, CLI may degrade wireless communications at the first communication device. To mitigate or reduce effects of CLI, the first network entity may configure the first communication device to measure and report CLI. For example, the first network entity may configure the first communication device to perform a CLI measurement on a reference signal transmitted from the second communication device. In some cases, however, a degree of CLI experienced at the first communication device due to full-duplex operations may be different from a degree of CLI experienced at the first communication device due to dynamic TDD operations. In other words, a degree of CLI experienced at the first communication device during a TTI used or allocated for dynamic TDD operations may be different from a degree of CLI experienced at the first communication device during a TTI used or allocated for full-duplex operations.

Various aspects of the present disclosure generally relate to techniques for CLI reporting for multiple types of TTIs and, more specifically, to a framework for configuring a communication device with CLI reporting parameters that are associated with one or more types of TTIs. For example, in accordance with such techniques, the first network entity may configure the first communication device with parameter for reporting CLI experienced at the first communication device during one or multiple types of TTIs. For example, the first network entity may configure the first communication device with parameters for reporting CLI experienced at the first communication device during a TTI used or allocated for dynamic TDD operations, or during a TTI used or allocated for full-duplex operations, or both. In some examples, the first communication device may receive control information that indicates first parameter information for reporting CLI that is associated with a first type of TTI. In such an example, the first communication device may measure CLI during resources that occur during TTIs of the first type. For example, the first communication device may receive one or more CLI reference signals from the second communication device during one or more TTIs of the first type of TTI. In such an example, the first communication device may measure and report CLI based on the one or more CLI reference signals. For example, the first communication device may transmit a report including information indicative of CLI that is associated with the one or more CLI reference signals.

In some examples, such as during a TTI used or allocated for SBFD operations, multiple non-contiguous sub-bands may be configured for downlink communications. In such examples, the first network may configure the first communication device with one or multiple sets of resources within the TTI that may be allocated for measuring CLI. For example, the first communication device may receive control information that indicates resource allocation information for measuring CLI. In such an example, the first communication device may receive one or more CLI signals from the second communication device via one or more CLI resources in accordance with the resource allocation information. For example, the one or more CLI resources may be within one or more sub-bands of the multiple non-contiguous sub-bands configured for (e.g., allocated for) downlink communication. In such an example, the first communication device may measure and report CLI based on the one or more CLI reference signals. For example, the first communication device may transmit a report including information indicative of CLI associated with the one or more CLI reference signals.

Particular aspects of the subject matter described herein may be implemented to realize one or more of the following potential advantages. For example, the techniques employed by the described communication devices may provide benefits and enhancements to the operation of the communication devices, including enabling CLI reporting for multiple types of TTIs. In some examples, operations performed at one or more of the communication devices to enable reporting of multiple types of TTIs may lead to increased communication reliability and reduced latency within a wireless communications system, among other benefits.

Aspects of the disclosure are initially described in the context of wireless communications systems. Aspects of the disclosure are also described in the context of an interference measurement diagram and process flows. Aspects of the disclosure are further illustrated by and described with reference to apparatus diagrams, system diagrams, and flowcharts that relate to CLI reporting for multiple types of TTIs.

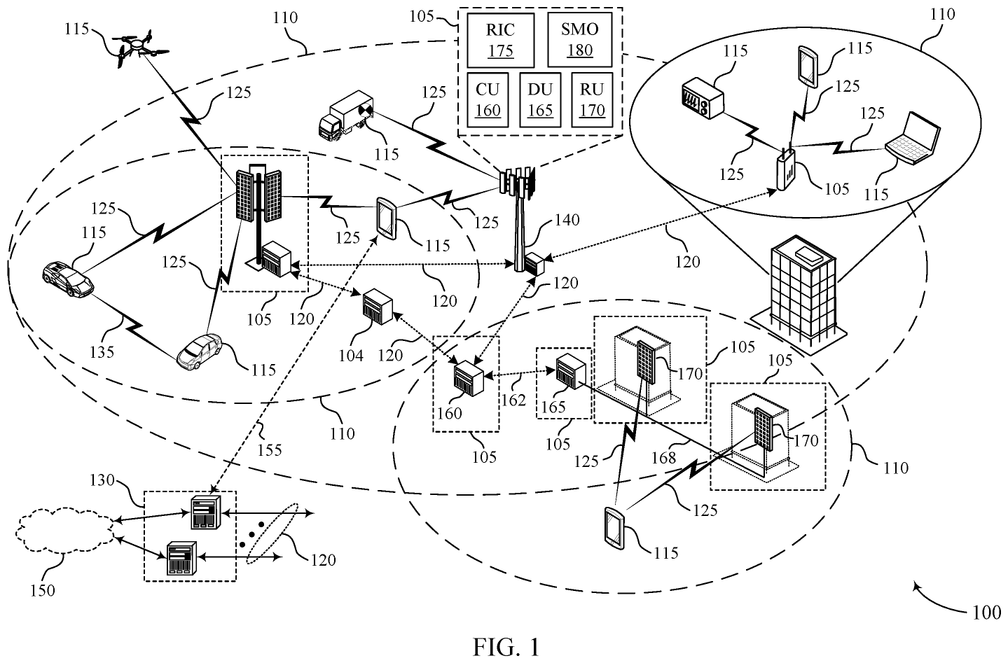

FIG. 1 shows an example of a wireless communications system 100 that supports CLI reporting for multiple types of TTIs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support CLI reporting for multiple types of TTIs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a TTI. In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Various devices within the wireless communications system 100 may support one or more levels of duplex operation, which may depend on or be associated with a deployment scenario, a duplex mode (such as TDD only, FDD only, or both TDD and FDD), or an interference management procedure. In some aspects, a wireless device (e.g., a UE 115, a network entity 105, or an IAB node 104) within the wireless communications system 100 may support half-duplex or full-duplex operation. For example, a network entity 105 may support various types of MIMO communication, including downlink multi-user MIMO (MU-MIMO) according to which the network entity 105 may transmit downlink signaling to two different UEs 115 simultaneously, uplink MU-MIMO according to which the network entity 105 may receive uplink signaling from two different UEs 115 simultaneously, or downlink and uplink MU-MIMO (which may be referred to herein as full-duplex operation) according to which the network entity 105 may transmit downlink signaling to a first UE 115 while simultaneously receiving uplink signaling from a second UE 115. A network entity 105 may further support enhanced MIMO (eMIMO) or further enhanced MIMO (FeMIMO), which may be associated with an FeMIMO beam management session. In accordance with full-duplex operation, a wireless device may be capable of transmitting and receiving simultaneously. In other words, the wireless device may support simultaneous uplink and downlink transmissions (such as an uplink transmission and a downlink transmission that at least partially overlap in time). In some examples, simultaneous uplink and downlink transmissions at a wireless device may lead to one or more types of interference at the wireless device or at a neighboring wireless device, or both. For example, the simultaneously uplink and downlink transmissions at a wireless device may lead to self-interference, CLI, interference caused by clutter (e.g., by objects such as buildings reflecting transmitted signaling), or any combination thereof.

In some aspects, a network entity 105 and a UE 115 may support various evaluation techniques and performance evaluation metrics associated with different deployment scenarios for full-duplex operation (such as for NR duplexing). Further, a network entity 105 and a UE 115 may support one or more techniques to support co-existence with other systems in any co-channels or adjacent channels for sub-band non-overlapping full-duplex operation or for dynamic or flexible TDD, or for both. For example, a network entity 105 and a UE 115 may support techniques associated with duplex operation evolution for NR TDD across various spectrums, including in an unpaired spectrum. In such examples, the network entity 105 may support full-duplex operation, a UE 115 may support half-duplex operation, and the network entity 105 and the UE 115 may configure or expect some relatively reduced constraints (e.g., reduced or no restrictions) on which frequency ranges may be available for use.

Such techniques may include various full-duplex types or schemes and corresponding metrics to evaluate a performance of such full-duplex types or schemes, inter-network entity (e.g., inter-gNB) and inter-UE CLI mitigation techniques, intra-sub-band CLI and inter-sub-band CLI mitigation techniques (such as in the implementation of sub-band non-overlapping full-duplex), or a metric-based evaluation procedure for an impact of full-duplex operation on half-duplex operation (assuming co-existence in co-channel and adjacent channels). Additionally, or alternatively, such techniques may include a metric-based evaluation procedure for an impact on RF constraints considering adjacent channel co-existence or for an impact on RF constraints considering self-interference, inter-sub-band CLI and inter-operator CLI at network entities 105, and inter-sub-band CLI and inter-operator CLI at UEs 115. Further, such techniques may include antenna or RF and algorithm design for interference mitigation, including antenna isolation, transmission interference management suppression in a receive-side part, filtering, and digital interference suppression. Further, such techniques may comply with one or more regulatory or network specifications associated with full-duplex operation in TDD unpaired spectrums.

Further, some systems may support one or more techniques associated with dynamic or flexible TDD or sub-band full-duplex (SBFD), or both, for inter-UE CLI handling (e.g., UE-to-UE CLI handling) or inter-gNB CLI handling (gNB-to-gNB CLI handling), or both. Such techniques may include mechanisms related to UE-to-UE CLI measurement and reporting, coordinated scheduling, spatial domain designs, receiver designs, UE and network entity transmission and reception timing, power control-based designs, or sensing-based mechanisms, among other example techniques associated with UE-to-UE CLI handling or gNB-to-gNB CLI handling. In some aspects, such techniques may be associated with an identification of whether a scheme or design include over-the-air (OTA) or backhaul information exchanges.

Various devices within the wireless communications system 100 may support inter-device CLI measurements. For example, one or more UEs 115 and network entities 105 may support techniques for measurement of CLI experienced at a UE 115 due to uplink transmissions from another UE 115. As described herein, measurement of CLI experienced at a UE 115 due to signaling from another UE 115 may be referred to as UE-to-UE CLI measurements. Additionally, as described herein, reference signals transmitted from a UE 115 for CLI measurements (e.g., UE-to-UE CLI measurements) at another UE 115 may be referred to as UE-to-UE CLI reference signals. In some cases, the UE 115 may experience UE-to-UE CLI due to dynamic TDD operations or full-duplex operations (or both) at a network entity 105 serving the UE 115. In such cases, a degree of CLI experienced at the UE 115 due to the full-duplex operations may be different from a degree of CLI experienced at the UE 115 due to the dynamic TDD operations. In other words, a degree of CLI experienced at the UE 115 during a TTI used at or allocated by the network entity 105 for dynamic TDD operations may be different from a degree of CLI experienced at the UE 115 during a TTI used at or allocated by the network entity 105 for full-duplex operations. However, the network entity 105 may lack a mechanism, much less an effective mechanism, for configuring the UE 115 with multiple (e.g., different) parameters for measuring or reporting UE-to-UE CLI experienced at the UE 115 during multiple (e.g., different) types of TTIs.

In some examples, the UE 115 and the network entity 105 may be configured to support one or more techniques for CLI reporting for multiple types of TTIs. For example, the network entity 105 may support a framework for configuring the UE 115 with CLI reporting parameters that are associated with one or more types of TTIs. In some examples, the UE 115 may receive control information that indicates first parameter information for reporting CLI that is associated with a first type of TTI (e.g., a TTI allocated for dynamic TDD operations, a TTI configured for full-duplex operations). In such an example, the UE 115 may receive one or more CLI reference signals from another UE 115 during one or more TTIs of the first type of TTI. Accordingly, the UE 115 may transmit a report including information indicative of CLI that is associated with the one or more CLI reference signals. In some examples, configuring the first UE 115 with CLI reporting parameters that are associated with the first type of TTI may lead to increased communication reliability and reduced latency within the wireless communications system 100, among other possible benefits.

In some examples, during a TTI used or allocated for full-duplex operations (e.g., SBFD operations), multiple non-contiguous sub-bands may be configured for downlink communications. In such examples, UE 115 may receive control information that indicates resource allocation information for measuring CLI. Accordingly, the UE 115 may receive one or more CLI signals from the other UE 115 via one or more CLI resources indicated via the resource allocation information. In some examples, the one or more CLI resources may be within one or more sub-bands of the multiple non-contiguous sub-bands configured for downlink communication. As such, the UE 115 may measure and report CLI based on the one or more CLI reference signals. For example, the UE 115 may transmit a report including information indicative of CLI associated with the one or more CLI reference signals. In some examples, configuring the first UE 115 with CLI resources to use for measuring CLI associated with non-contiguous sub-bands may lead to increased communication reliability and reduced latency within the wireless communications system 100, among other possible benefits.

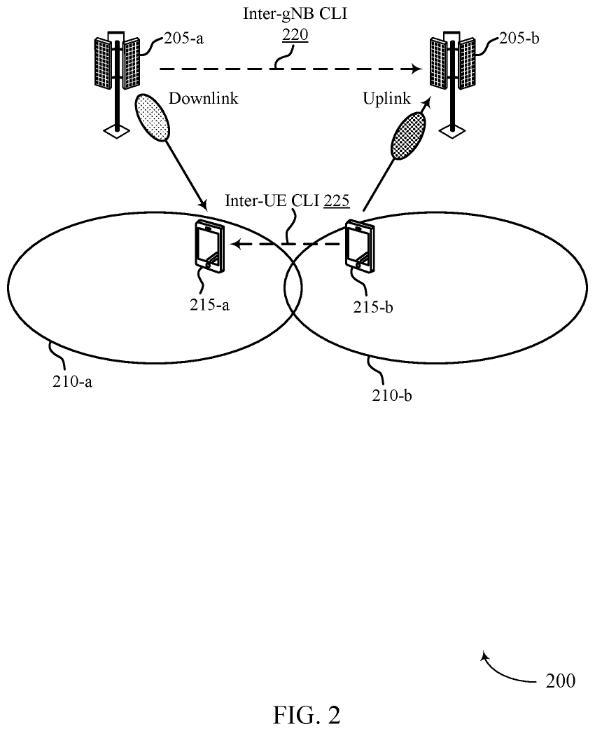

FIG. 2 shows an example of a wireless communications system 200 that supports CLI reporting for multiple types of TTIs in accordance with one or more aspects of the present disclosure. The wireless communications system 200 may implement or be implemented to realize or facilitate aspects of the wireless communications system 100. For example, the wireless communications system 200 may include a UE 215-a and a UE 215-b as well as a network entity 205-a and a network entity 205-b. The UE 215-a and the UE 215-b may each be an example of a UE 115 illustrated by and described with reference to FIG. 1. The network entity 205-a and the network entity 205-b may each be an example of a network entity 105 illustrated by and described with reference to FIG. 1. In the example of FIG. 2, the network entity 205-a may be associated with (e.g., serve) a cell 210-a and the network entity 205-b may be associated with (e.g., serve) a cell 210-b.

In some examples of the wireless communications system 200, the network entities 205 may operate in a dynamic TDD mode, which may also be referred to as a flexible TDD mode. Operating in a dynamic TDD mode may enable the network entities 205 to adjust uplink and downlink resources flexibly, for example, based on traffic load (e.g., instantaneous traffic load) within the wireless communications system 200. In some examples, a dynamic TDD mode may include half-duplex operations (e.g., at the network entities 205) with a misaligned TTI format (e.g., a misaligned slot format, a misaligned symbol format). Operating in a dynamic TDD mode may enable increased flexibility for asymmetric services, which may lead to improved spectral efficiency within the wireless communications system 200, among other possible benefits.

In some examples, however, dynamic TDD operations at the network entities 205 may lead to interference between downlink and uplink communications within the wireless communications system 200. For example, dynamic TDD operations at the network entities 205 may enable the network entity 205-a to transmit downlink communications and the network entity 205-b to receive uplink communications concurrently (or overlapping in time), which may lead to inter-gNB CLI 220 at the network entity 205-b. Accordingly, the UE 215-a may receive the downlink communications from the network entity 205-a and the UE 215-b may transmit the uplink communications to the network entity 205-b concurrently (or overlapping in time), which may lead to inter-UE CLI 225 experienced at the UE 215-a. In other words, in some deployment scenarios, such as in deployment scenarios in which the UE 215-a and the UE 215-b are relatively near each other (e.g., despite being served by different cells), uplink signaling transmitted from the UE 215-b (e.g., to the network entity 205-b) may cause inter-UE CLI 225 (e.g., inter-cell inter-UE interference) at the UE 215-a. In some aspects, a UE experiencing CLI (e.g., a UE receiving downlink signals, such as the UE 215-a) may be referred to as a victim UE and a UE causing CLI (e.g., a UE transmitting uplink signals, such as the UE 215-b) may be referred to as an aggressor UE.

In some implementations, one or more of the network entities 205 and one or more of the UEs 215 may support techniques associated with inter-UE CLI mitigation for deployments involving dynamic TDD scenarios, such as may be illustrated in the example of FIG. 2. For example, one or both of the network entities 205 and one or both of the UEs 215 may support UE-to-UE CLI reporting. In some examples, to support CLI reporting, one or both of the UEs 215 may support UE-to-UE CLI measurements. In some examples, to reduce inter-cell CLI and improve decoding of downlink signals at the UE 215-a, the network entity 205-a may configure the UE 215-a to perform one or more CLI measurements (e.g., an RSRP measurement or RSSI measurement) on a reference signal transmitted from the UE 215-b.

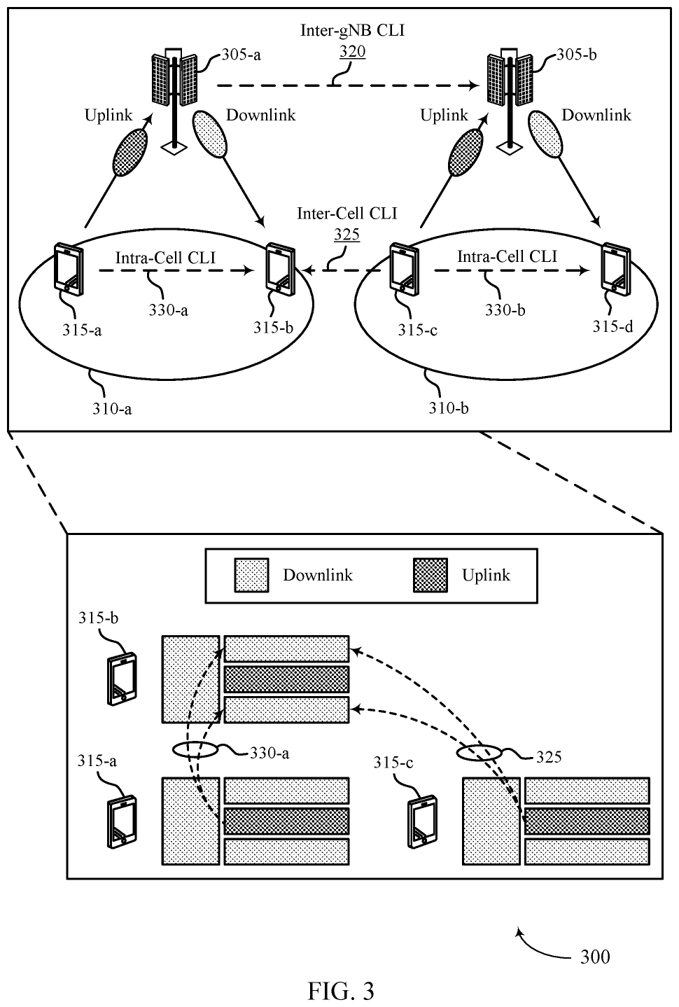

FIG. 3 shows an example of an interference measurement diagram 300 that supports CLI reporting for multiple types of TTIs in accordance with one or more aspects of the present disclosure. The interference measurement diagram 300 may implement or be implemented to realize or facilitate aspects of the wireless communications system 100 and the wireless communications system 200. For example, the interference measurement diagram 300 illustrates interference or potential interference (and corresponding interference measurements) between various wireless communication devices, including a UE 315-a, a UE 315-b, a UE 315-c, and a UE 315-d as well as a network entity 305-a and a network entity 305-b. The UE 315-a, the UE 315-b, the UE 315-c, and the UE 315-d may each be an example of a UE illustrated by and described with reference to FIGS. 1 and 2. The network entity 305-a and the network entity 305-b may each be an example of a network entity illustrated by and described with reference to FIGS. 1 and 2.

In the example of FIG. 3, the network entity 305-a may be associated with a cell 310-a and the network entity 305-b may be associated with a cell 310-b. Within the cell 310-a, the UE 315-a may transmit signaling (e.g., uplink signaling) to the network entity 305-a that may cause intra-cell CLI 330-a at the UE 315-b. Similarly, within the cell 310-b, the UE 315-c may transmit signaling (e.g., uplink signaling) to the network entity 305-b that may cause intra-cell CLI 330-b at the UE 315-d. In some aspects, a UE experiencing CLI (e.g., a UE receiving downlink signals, such as the UE 315-b or the UE 315-d) may be referred to as a victim UE and a UE causing CLI (e.g., a UE transmitting uplink signals, such as the UE 315-a or the UE 315-c) may be referred to as an aggressor UE.

In some deployment scenarios, such as in deployment scenarios in which the UE 315-b and the UE 315-c are relatively near each other (e.g., despite being served by different cells), the signaling transmitted from the UE 315-c (e.g., to the network entity 305-b) may cause inter-cell CLI 325 at the UE 315-b. The inter-cell CLI 325 may be an example of inter-UE CLI illustrated by and described with reference to FIG. 2. For example, the UE 315-b may experience inter-cell CLI 325 from the UE 315-c in scenarios in which the network entity 305-a and the network entity 305-b support dynamic TDD operation. As such, the UE 315-b may experience intra-cell CLI 330-a or inter-cell CLI 325, or both. Further, in some deployment scenarios, the network entity 305-a may transmit signaling (such as downlink signaling to the UE 315-b) that may cause inter-gNB CLI 320. The inter-gNB CLI 320 may be an example of inter-gNB CLI illustrated by and described with reference to FIG. 2.

In examples the network entities 305 (e.g., the network entity 305-a and the network entity 305-b) may support SBFD (e.g., full-duplex communications using resources configured for SBFD). That is, the network entities 305 may support simultaneous transmission of downlink signals and reception of uplink signals on a sub-band basis. In such an example, the network entities 305 (e.g., full-duplex gNBs) may support simultaneous transmission of downlink signals and reception of uplink signals in a same slot. In some examples, SBFD may provide an increase in an uplink duty cycle which may lead to latency reduction. For example, SBFD operations may enable transmission of an uplink signal in slots allocated for downlink signaling or reception of a downlink signal in a slot allocated for uplink signaling, which may improve (e.g., decrease) communications latency. Additionally, SBFD may lead to enhanced system capacity, resource utilization, and spectrum efficiency, as well as enable flexible and dynamic uplink or downlink resource adaption according to uplink or downlink traffic in a relatively robust manner.

In some examples, such as examples in which the network entities 305 may support SBFD, the intra-cell CLI 330-a, the intra-cell CLI 330-b, the inter-cell CLI 325, and the inter-gNB CLI 320 may include inter-sub-band CLI. For example, during a slot configured for SBFD at the network entity 305-a, the UE 315-a may transmit an uplink signal to the network entity 305-a using one or more uplink sub-bands within the slot, while the network entity 305-a may simultaneously use a downlink sub-band to transmit a downlink signal to the UE 315-b. As such, the uplink signal transmitted from the UE 315-a may cause intra-cell CLI 330-a at the UE 315-b. Additionally, or alternatively, during the slot configured for SBFD at the network entity 305-a and the network entity 305-b, the UE 315-c may transmit an uplink signal to the network entity 305-b using one or more uplink sub-bands within the slot, while the network entity 305-a may simultaneously use a downlink sub-band to transmit a downlink signal to the UE 315-b. As such, the uplink signal transmitted from the UE 315-c may cause inter-cell CLI 325 at the UE 315-b.

Additionally, or alternatively, in some examples, the network entity 305-a and the network entity 305-b may support fully or partially overlapped full-duplex. In such examples, the intra-cell CLI 330-a, the intra-cell CLI 330-b, the inter-cell CLI 325, and the inter-gNB CLI 320 may include intra-sub-band CLI. Accordingly, in some example deployments, such as deployments in which the network entity 305-a and the network entity 305-b may communicate and schedule communication according to a network-side SBFD mode, the UE 315-b may experience inter-sub-band, intra-cell, inter-UE CLI from the UE 315-a (such as the intra-cell CLI 330-a) and inter-sub-band, inter-cell, inter-UE CLI from the UE 315-c (such as the inter-cell CLI 325).

In some deployments, the network entity 305-a and the network entity 305-b may each experience some amount of inter-sub-band or intra-sub-band, inter-gNB CLI (e.g., the inter-gNB CLI 320). For example, the network entity 305-a may transmit downlink signaling via one or more downlink sub-bands and such downlink signaling may cause the inter-gNB CLI 320 in one or more uplink sub-bands (in addition to one or more downlink sub-bands) at the network entity 305-b. Similarly, the network entity 305-b may transmit downlink signaling via one or more downlink sub-bands and such downlink signaling may cause the inter-gNB CLI 320 in one or more uplink sub-bands (in addition to one or more downlink sub-bands) at the network entity 305-a.

In some implementations, one or more of the network entities 305 and one or more of the UEs 315 may support techniques associated with inter-UE CLI mitigation for deployments involving sub-band non-overlapping full-duplex scenarios, for deployments involving partially or fully overlapping full-duplex scenarios, or for deployments involving dynamic TDD scenarios, or any combination thereof. For example, one or more of the network entities 305 may support a framework for configuring one or more of the UEs 315 to measure and report CLI that may be associated with one or multiple types of TTIs, such as TTIs associated with sub-band non-overlapping full-duplex scenarios (e.g., SBFD TTIs), TTIs associated with partially or fully overlapping full-duplex scenarios (e.g., non-SBFD TTIs), or TTIs associated with dynamic TDD scenarios (e.g., aligned or misaligned dynamic TDD TTIs). Additionally, or alternatively, the one or more network entities 305 may support a framework for configuring one or more of the UEs 315 to measure and report CLI that may be associated with non-contiguous sub-bands (e.g., included in a SBFD TTI). In some examples, such frameworks may lead to increased accuracy for CLI measurements, among other benefits.

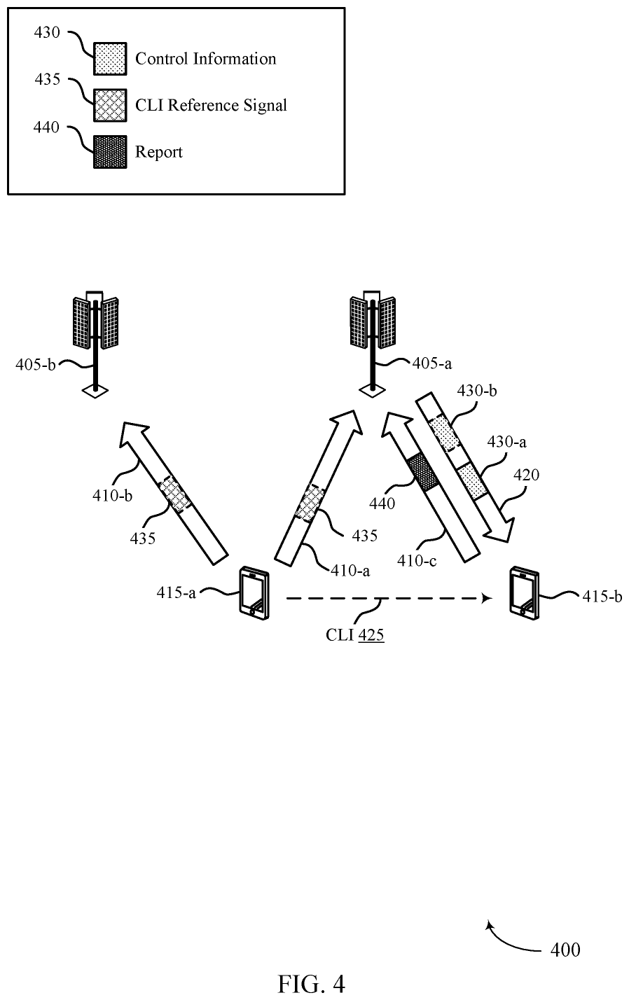

FIG. 4 shows an example of a wireless communications system 400 that supports CLI reporting for multiple types of TTIs in accordance with one or more aspects of the present disclosure. The wireless communications system 400 may implement or be implemented to realize or facilitate aspects of the wireless communications system 100, the wireless communications system 200, and the interference measurement diagram 300. For example, the wireless communications system 400 includes a UE 415-a and a UE 415-b, which may be examples of UEs illustrated by and described with reference to FIGS. 1 and 2. Additionally, the wireless communications system 400 includes a network entity 405-a and a network entity 405-b, which may be examples of network entities illustrated by and described with reference to FIGS. 1 and 2. The network entities 405 may communicate with one or more of the UEs 415 via one or more communication links. For example, the network entity 405-a may communicate with the UE 415-a via an uplink 410-a. Additionally, the network entity 405-a may communicate with the UE 415-b via an uplink 410-c and a downlink 420. The network entity 405-b may communicate with the UE 415-a via an uplink 410-b. In some examples, the uplinks 410 and the downlink 420 may each be an example of a communication link 125 (e.g., a Uu interface) illustrated by and described with reference to FIG. 1.

In some examples of the wireless communications system 400, one or both of the network entities 405 may support full-duplex operations (e.g., SBFD operations) or dynamic TDD operations in which one or both of the network entities 405 may simultaneously or concurrently transmit downlink signals and receive uplink signals. For example, the UE 415-a may transmit uplink signaling to the network entity 405-a while the UE 415-b simultaneously receives downlink signaling from the network entity 405-a. In some other examples, the UE 415-a may transmit uplink signaling to the network entity 405-b while the UE 415-b receives downlink signaling from the network entity 405-a. The uplink signaling transmitted from the UE 415-a (e.g., an aggressor UE) may cause CLI 425 at the UE 415-b. The CLI 425 may be an example of inter-cell CLI or intra-cell CLI illustrated by an described with reference to FIG. 3.

For example, the CLI 425 may be associated with sub-band non-overlapping full-duplex scenarios, partially or fully overlapping full-duplex scenarios, or dynamic TDD scenarios, or any combination thereof. That is, the CLI may occur during one or more TTIs associated with (e.g., allocated for, used for) sub-band non-overlapping full-duplex operations, partially or fully overlapping full-duplex operations, or dynamic TDD operations. As described herein, a TTI associated with (e.g., allocated for) for SBFD operations may include a TTI during which one or both of the network entities 405 may simultaneously transmit and receive on a sub-band basis. Accordingly, a TTI associated with sub-band non-overlapping full-duplex operations may be referred to as a SBFD TTI (e.g., a SBFD symbol or slot). As described herein, a TTI associated with (e.g., allocated for) for partially or fully overlapping full-duplex operations may include a TTI (or a portion of a TTI) during which the network entities 405 may simultaneously (or concurrently) transmit and receive communications in accordance with a full-duplex mode. That is, a format of the TTI (or a portion of the TTI) may be misaligned across the network entities 405. For example, the TTI (or a portion of the TTI) may be allocated for downlink at the network entity 405-a and allocated for uplink at the network entity 405-b, such that the UE 415-a may transmit uplink signaling to the network entity 405-b while the UE 415-b receives downlink signaling from the network entity 405-a. Accordingly, a TTI associated with partially or fully overlapping full-duplex operations may be referred to as a non-SBFD TTI (e.g., a non-SBFD symbol or slot). As described herein, a TTI associated with (e.g., allocated for) with dynamic TDD operations may include a TTI during which the network entities 405 may simultaneously (or concurrently) transmit and receive communications in accordance with a half-duplex mode. For example, the TTI (or a portion of the TTI) may be allocated for downlink communications at the network entity 405-a and uplink communications at the network entity 405-b, such that the network entity 405-a may transmit downlink communications while the network entity 405-b receives uplink communications. In such an example, the format of the TTI may be misaligned between the network entities 405 (e.g., across respective cells served by the network entities 405). A misaligned TTI associated with dynamic TDD operations may be referred to as a misaligned dynamic TDD TTI (e.g., a misaligned dynamic TDD symbol or slot). In some other examples, the TTI may be allocated for downlink communications or uplink communications at the network entity 405-a and the network entity 405-b, such that the network entity 405-a and the network entity 405-b may simultaneous (or concurrently) transmit downlink communications or receive uplink communications. In such an example, the format of the TTI may be aligned between the network entities 405 (e.g., across respective cells served by the network entities 405). An aligned TTI associated with dynamic TDD operations may be referred to as an aligned dynamic TDD TTI (e.g., an aligned dynamic TDD symbol or slot). In some examples, a likelihood of one or both of the UEs 415 experiencing CLI during an aligned dynamic TDD TTI may be relatively low compared to a likelihood of one or both of the UEs 415 experiencing CLI during a misaligned dynamic TDD TTI, a SBFD TTI, or a non-SBFD TTI.

To reduce or mitigate the CLI 425 and improve decoding of downlink signals at the UE 415-b, the network entity 405-a may configure the UE 415-b to perform one or more CLI measurements (e.g., one or more RSRP measurements or one or more RSSI measurements) using one or more reference signals transmitted from the UE 415-a (e.g., to the network entity 405-a or the network entity 405-b). In such an example, the network entity 405-a may transmit control signaling (e.g., a report configuration) to configure the UE 415-b to perform one or more CLI measurements (e.g., one or more UE-to-UE CLI measurements). For example, the network entity 405-a may transmit a report configuration (e.g., downlink control information (DCI), an RRC message, a MAC control element (MAC-CE)) that indicates one or more parameters for measurement or reporting of CLI experienced at the UE 415-b, for example, due to signaling from the UE 415-a. In other words, a report configuration may include parameter information that may be indicative of one or more parameters for measuring or reporting the CLI 425. The one or more parameters may include a type of CLI metric to be reported (e.g., whether the UE 415-b is to report a value of an RSSI metric value or a value of an RSRP metric), one or more resources during which the UE 415-b may measure CLI (e.g., one or more CLI measurement resources), or one or more resources during which the UE 415-b may transmit a report including information indicative of CLI (e.g., one or more CLI reporting resources), among other examples of parameters that may be used for measurement or reporting of interference. That is a report configuration (e.g., control information) may include information indicative of a type of CLI metric to be reported, may include information indicating an allocation of one or more resources for measurement of CLI (e.g., one or more CLI measurement resources), or may include information indicating an allocation of one or more resources allocated for reporting of CLI (e.g., one or more CLI reporting resources). In some examples, a CLI measurement resource used for (or allocated for) the measurement of a RSSI may be referred to as a CLI-RSSI resource and a CLI measurement resource used for (or allocated for) the measurement of a RSRP may be referred to as a CLI-RSRP resource. Additionally, in some examples, a resource used for (or allocated for) the measurement of CLI experienced at the UE due to signaling from another UE may be referred to as a UE-to-UE CLI measurement resource.

As illustrated in the example of FIG. 4, the network entity 405-a may transmit control information 430-a (e.g., a report configuration) to the UE 415-b that may indicate one or more CLI resources (e.g., CLI-RSRP resources, CLI-RSSI resources) that the UE 415-b may use to measure CLI experienced at the UE 415-b due to signaling from the UE 415-a (e.g., to measure the CLI 425). In such an example, the one or more CLI resources may include a time-frequency resource that the UE 415-a may use (or may be scheduled to use) for transmission of an uplink reference signal (e.g., a CLI reference signal 435, such as a sounding reference signal (SRS)) to the network entity 405-a or the network entity 405-b. In other words, the control information 430-a may indicate a CLI measurement resource (e.g., a UE-to-UE CLI measurement resource) that correspond to (or is associated with) a CLI reference signal resource occupied (or allocated for) the CLI reference signal 435. The control information 430-a may indicate one or more other parameters for measurement or reporting of the CLI 425. A degree of CLI experienced at the UE 415-b due to full-duplex operations (e.g., during SBFD TTIs or non-SBFD TTIs) may be different from a degree of CLI experienced at the UE 415-b due to dynamic TDD operations (e.g., during aligned TDD TTIs or misaligned dynamic TDD TTIs). Accordingly, one or more parameters used for measurement or reporting of CLI associated with full-duplex operations may be different from one or more parameters used for measurement or reporting of CLI associated with dynamic TDD operations. In other words, one or more parameters used for measurement or reporting of CLI on (e.g., CLI experienced during) during SBFD TTIs, non-SBFD TTIs, aligned TDD TTIs, and misaligned dynamic TDD TTIs may be different. In some examples, however, the network entity 405-a may lack a mechanism, much less an effective mechanism, for indicating multiple (e.g., different) parameters for measurement or reporting of CLI associated with multiple (e.g., different) types of TTIs.

In some other examples, one or both of the network entities 405 may support a framework for configuring the UE 415-a (or the UE 415-b) to measure and report CLI on multiple types of TTIs. For example, one or both of the network entities 405 and one or both of the UEs 415 may support one or more report configurations for inter-UE CLI on multiple types of TTIs (e.g., two or more types of symbols or slots). As illustrated in the example of FIG. 4, the network entity 405-a may transmit the control information 430-a (e.g., a report configuration) to the UE 415-b. In some examples, the control information 430-a may indicate parameter information for reporting the CLI 425. That is, the control information 430-a may include information indicative of at least one parameter for measurement or reporting of the CLI 425.

In some examples, one or both of the network entities 405 and one or both of the UEs 415 may support multiple (e.g., separate) report configurations CLI for multiple types of TTIs. In other words, one or both of the network entities 405 and one or both of the UEs 415 may support multiple report configurations for two (or more) types of symbols or slots. In some examples, the multiple report configurations may be for two types of symbols or slots. In such examples, the two types of slots or symbols may be SBFD and non-SBFD symbols or slots. Additionally, or alternatively, the two types of symbols or slots may be aligned dynamic TDD and misaligned dynamic TDD symbols or slots. In some other examples, the multiple report configurations may be for more than two types of slots or symbols. In such examples, the more than two types of symbols or slots may be SBFD symbols or slots, non-SBFD symbols or slots, or misaligned dynamic TDD symbols or slots. As an illustrative example, the parameter information (e.g., included in the control information 430-a) may include first parameter information that is associated (e.g., in the control information 430-a) with a first type of TTI, which may include an SBFD TTI type, a non-SBFD TTI type, a misaligned dynamic TDD TTI type, an aligned dynamic TDD TTI type, or a non-SBFD misaligned dynamic TDD TTI. In some examples, the control information 430-a may include an indication that the first parameter information is applicable to TTIs of the first type of TTI. In some other examples, the UE 415-b may autonomously determine that the first parameter information is applicable to TTIs of the first type of TTI.

The control information 430-a may configure the UE 415-b to report CLI on TTIs of the first type. That is, the control information 430-a may configure the UE 415-b to measure or report CLI experienced at (e.g., detectable at, measured at) the UE 415-b during one or more TTIs of the first type. For example, the UE 415-b may receive the CLI reference signal 435 during one or more TTIs of the first type of TTI, which may lead to the CLI 425. Accordingly, the UE 415-b may measure (and report on) the CLI 425 during the one or more TTIs. In some examples, the UE 415-b may transmit a report 440, which may include information indicative of the CLI 425 (e.g., may be indicate of CLI measured at the UE 415-b during the one or more TTIs). The information indicative of the CLI 425 may be associated with (e.g., based on) the CLI reference signal 435. For example, the UE 415 may generate the information indicative of the CLI 425 based on the CLI reference signal 435 (e.g., based on one or more CLI measurements of the CLI reference signal 435).

In some examples, the UE 415-a may be configured to measure and report CLI for multiple types of TTIs. For example, the UE 415-b may receive control information 430-b (e.g., in addition to the control information 430-a), which may include second parameter information that is associated (e.g., in the control information 430-b) with a second type of TTI or a third type of TTI. As an illustrative example, the first type of TTI may include the SBFD TTI type, the second type of TTI may include a non-SBFD TTI type, and the third type of TTI may include a misaligned dynamic TDD TTI type. In such an example, the control information 430-a may correspond to a single report configuration (e.g., a single CLI report configuration or a single CLI information element (IE) within a channel state information (CSI) report configuration) for the first type of TTI (e.g., for SBFD TTIs). That is, the control information 430-a may configure (e.g., only configure) the UE 415-b to report CLI on SBFD symbols or slots. In other words, the first parameter information included in the control information 430-a may be for reporting CLI that is associated with a SBFD operation mode at the network entity 405-a. Accordingly, the control information 430-a (e.g., a first CSI report configuration, a first CLI report configuration) may configure the UE 415-b to measure CLI that may be associated with resources (e.g., CLI resources) within SBFD symbols or slots. In some examples, the CLI resources may include periodic, semi-periodic, or aperiodic CLI resources. In other words, the control information 430-a may configure the UE 415-b to measure (and report) CLI associated with periodic, semi-periodic, or aperiodic CLI resources within one or more SBFD symbols or slots.

In some examples, the control information 430-b may correspond to a single report configuration (e.g., a single CLI report configuration or a single CLI IE within a CSI report configuration) for the second type of TTI (e.g., for non-SBFD TTIs) or for the third type of TTI (e.g., for misaligned dynamic TDD TTIs). That is, the control information 430-b may configure (e.g., only configure) the UE 415-b to report CLI on non-SBFD symbols or slots or on misaligned dynamic TDD symbols or slots. In other words, the second parameter information may be for reporting CLI that is associated with a full-duplex operation mode at the network entity 405-a or a dynamic TDD operation mode at the network entity 405-a (e.g., a half-duplex operation mode at the network entity 405-a and with a misaligned TTI format). Accordingly, the control information 430-b (e.g., a second CSI or CLI report configuration) may configure the UE 415-b to measure CLI associated with CLI resources within non-SBFD symbols or slots (e.g., to measure periodic, semi-periodic, or aperiodic CLI resources within one or more non-SBFD symbols or slots). Alternatively, the control information 430-b (e.g., the second CSI or CLI report configuration) may configure the UE 415-b to measure CLI associated with CLI resources within misaligned dynamic TDD symbols or slots (e.g., to measure periodic, semi-periodic, or aperiodic CLI resources within one or more misaligned dynamic TDD symbols or slots). In some examples, the network entity 405-a may configure the UE 415-b to measure CLI associated with CLI resources within non-SBFD symbols or slot, for example, if a format of the non-SBFD symbols or slots is misaligned between the network entity 405-a and the network entity 405-b (e.g., if the non-SBFD symbols or slots are allocated for downlink at the network entity 405-a and uplink at the network entity 405-b). That is, non-SBFD symbols or slots that may be misaligned between neighbor cells (e.g., the cells served via the network entities 405), which may impact (e.g., cause, lead to) the CLI 425. Accordingly, network entity 405-a may configure the UE 415-b to measure CLI associated with CLI resources within non-SBFD symbols or slot (e.g., non-SBFD misaligned dynamic TDD TTIs).

In some examples, the control information 430-a and the control information 430-b may be associated with one or multiple CLI resources. That is, multiple (e.g., separate) report configurations, such as the control information 430-a and the control information 430-b, may be linked to one or more same CLI resources or one or more different CLI resources. In other words, the control information 430-a may indicate a first set of one or more CLI resources associated with the first type of TTI (e.g., SBFD TTIs) and the control information 430-b may indicate a second set of CLI resources associated with the second type of TTI (e.g., non-SBFD TTIs) or the third type of TTI (e.g., misaligned dynamic TDD TTIs). In some examples, the first set of CLI resources and the second set of CLI resources may include different CLI resources. In some other examples, the first set of CLI resources and the second set of CLI resources may include one or more of the same CLI resources (e.g., one or more CLI resources may be common to both the first set of CLI resources and the second set of CLI resources). In some examples, the control information 430-a may include both the first parameter information and the second parameter information. For example, the control information 430-a may be an example of a CSI report configuration that includes a one or more first IEs or fields associated with CLI on the first type of TTI (e.g., the first parameter information) and a second one or more IEs or fields associated with CLI on the second or third type of TTI (e.g., the second parameter information). In some other examples, control information 430-a may be an example of a single report configuration (e.g., a CLI report configuration) that may include a first one or more IEs or fields associated with CLI on the first type of TTI (e.g., the first parameter information) and a second one or more IEs or fields associated with CLI on the second or third type of TTI (e.g., the second parameter information). In such examples, the control information 430-a may indicate both the first set of CLI resources associated with the first type of TTI and the second set of CLI resources associated with the second or third type of TTI.

In some examples, the control information 430-a may indicate one or more CLI reporting resource. For example, the control information 430-a may information indicative of a parameter (K). In such an example, the UE 415-b may determine that a CLI reporting resource be within a TTI that is at least K TTIs after a corresponding CLI measurement resource (e.g., the CLI resource occupied by the CLI reference signal 435). That is, a CLI resource to be used for transmitting the report 440, which may include information indicative of the CLI 425, may be within a TTI that is at least K TTIs after the TTI during which the UE 415-b may have measured the CLI 425 (e.g., the TTI including the CLI reference signal resource use to transmit the CLI reference signal 435). In other words, a CLI reporting resource to be used for transmitting the report 440 may be within a TTI that is K symbols or slots relative to an end of the corresponding CLI measurement resource (e.g., the CLI reference signal resource). In some examples, a value of K may include multiple types of TTIs. That is, K may be defined to be across a next K symbols or slots, regardless of symbol or slot type. In other words, the control information 430-a may indicate K TTIs (e.g., a minimum or otherwise suitable quantity of TTIs) between a reporting TTI in which the report 440 is to be transmitted and a reference TTI (e.g., the CLI resource occupied by the CLI reference signal) and the value of K may include TTIs of multiple types (e.g., of any type). In some examples, the UE 415-b may determine that a size of the report 440 exceeds (e.g., cannot fit in) the reporting TTI. In such examples, the UE 415-b may search (e.g., continue to search) for a next TTI that may accommodate the size of the report 440 (e.g., a next fitting symbol or slot). In some examples, a CLI reporting resource may be an example of a resource allocated to a physical uplink control channel (PUCCH). That is, a CLI reporting resource may be a PUCCH resource.

In some other examples, a value of K may include a single type of TTI. That is, K may counted over (e.g., only over) a single type of TTI, such as SBFD TTIs, non-SBFD TTIs, misaligned dynamic TDD TTIs, or aligned dynamic TDD TTIs. In some examples, the type of TTI associated with the parameter K may be based on the type of TTI that includes the corresponding CLI resource (e.g., the corresponding CLI measurement resource, the corresponding CLI reference signal resource). For example, the reference TTI (e.g., the CLI resource during with the CLI 425 is measured, the CLI resource occupied by the CLI reference signal 435) may be of the first type of TTI. Accordingly, the control information 430-a may indicate K TTIs (e.g., a minimum or otherwise suitable quantity of TTIs) between the reporting TTI (e.g., the TTI in which the report 440 is to be transmitted) and the reference TTI and the value of K may include TTIs of the first type (e.g., only the first type). In other words, the UE 415-b may transmit the report 440 K SFBD symbols or slots after the CLI resource occupying the CLI reference signal 435 (e.g., after the corresponding CLI resource indicated via the control information 430-a). In some examples, the UE 415-b may transmit another report for CLI reference signals received during TTIs of the second or third type of TTI. For example, the UE 415-b may transmit another report K TTIs (e.g., K non-SBFD slots or symbols, K misaligned dynamic TDD slots or symbols) after a corresponding CLI resource indicated via the control information 430-b.

In some examples, the control information 430-a may indicate parameter information for multiple types of TTIs. For example, one or both of the network entities 405 and one or both of the UEs 415 may support a single (e.g., a same) CLI report configuration for multiple types of TTIs. In other words, one or both of the network entities 405 and one or both of the UEs 415 may support a single report configuration for two (or more) types of symbols or slots. In some examples, the report configuration may be associated with two types of symbols or slots. In such examples, the two types of slots or symbols may be SBFD and non-SBFD symbols or slots. Accordingly, the control information 430-a may configure the UE 415-b to report CLI on both SBFD and non-SBFD symbols or slots. In some other examples, the two types of symbols or slots may be aligned dynamic TDD and misaligned dynamic TDD symbols or slots. In such examples, the control information 430-a may configure the ULE 415-b to report CLI on both aligned dynamic TDD and misaligned dynamic TDD symbols or slots. In some examples, the report configuration may be associated with more than two types of symbols or slots. In such examples, the more than two types of symbols or slots may be SBFD symbols or slots, non-SBFD symbols or slots, and misaligned dynamic TDD symbols or slots. In such an example, the control information 430-a may configure the UE 415-b to report CLI on SBFD slots or symbols, non-SBFD slots or symbols, and misaligned dynamic TDD symbols or slots.

For example, the control information 430-a may indicate the first parameter information associated with the first TTI type and the second parameter information associated with the second or third TTI type. In such examples, UE behavior may be constrained (e.g., restricted) to disable averaging of the CLI measurement results over multiple (e.g., different) TTI types. That is, the UE 415-b may refrain from averaging CLI measurement values across one or more TTIs of the first type and one or more TTIs of the second (or third) type. In some examples, the UE 415-b may disable (or may be configured to disable) one or more UE capabilities, at the ULE 415-b, that may be associated with (e.g., may support) CLI measurement averaging across multiple types of TTIs. In such examples, the UE 415-b may refrain from averaging CLI measurement values across one or more TTIs of the first type and one or more TTIs of the second (or third) type in response to disabling the one or more UE capabilities. In some examples, such as based on the refraining, the report 440 may indicate a first one or more CLI measurement values associated with the first TTI type and a second one or more CLI measurement values associated with the second (or third) TTI type. In some other examples, the report 440 may indicate the first one or more CLI measurement values associated with the first TTI type and the UE 415-b may transmit a second report that indicates the second one or more CLI measurement values associated with the second TTI type. The network entity 405-a may determine a TTI type associated with the report 440 (or a respective TTI type associated with each CLI measurement value indicated via the report 440). That is, the network entity 405-a may be aware of whether the report 440 is mapped to a CLI occasion in a SBFD symbol (e.g., is associated with the first type), a non-SBFD symbol (e.g., is associated with the second type), or a misaligned dynamic TDD TTI (e.g., is associated with the third type). In some examples, the network entity 405-a may apply the report 440 (e.g., information included in the report 440, such as information indicative of the CLI 425) based on the type of TTI associated with the report 440. That is, the network entity 405-b may know a type of symbols or slot associated with a CLI report and, as such, may use the CLI report accordingly on different symbol or slot types.

In some examples, the control information 430-a may indicate resource allocation information for measuring the CLI 425. For example, the control information 430-a may correspond to a report configuration for a SBFD TTI in which the network entity 405-a may transmit and receive on a sub-band bases. In such an example, the network entity 405-a may transmit a configuration of CLI resources (e.g., via the control information 430-a) on a set of non-contiguous sub-bands of the SBFD TTI that may be allocated for downlink communication (e.g., on two or more non-contiguous downlink sub-bands of the SBFD TTI). For example, the UE 415-a may receive the CLI reference signal 435 via one or more CLI resources in accordance with the resource allocation information (e.g., included in the control information 430-a). In such an example, the one or more CLI resources may be within one or more sub-bands of the set of non-contiguous sub-bands allocated for downlink communication.

In some examples, the CLI 425 may be relatively similar (e.g., symmetric) across multiple sub-bands included in the set of non-contiguous sub-bands allocated for downlink communication (e.g., in multiple non-contiguous downlink sub-bands). In such examples, the UE 415-b may measure CLI associated with a single downlink sub-band of the set of non-contiguous sub-bands allocated for downlink communication (e.g., with one of the multiple non-contiguous downlink sub-bands of the SBFD TTI). For example, the network entity 405-a (e.g., a gNB) may configure a single CLI resource (e.g., one CLI-RSSI or CLI-RSRP resource) for CLI measurement on one of the multiple non-contiguous downlink sub-bands of the SBFD TTI. In other words, the CLI reference signal 435 may occupy a single CLI resource that is within a sub-band of the set of non-contiguous sub-bands allocated for downlink communication.

In some other examples, the UE 415-b may measure CLI associated with multiple non-contiguous downlink sub-bands. That is, the UE 415-b may be configured to measure CLI associated with two or more downlink sub-band of the set of non-contiguous sub-bands allocated for downlink communication (e.g., two or more of the multiple non-contiguous downlink sub-bands of the SBFD TTI). For example, the network entity 405-a (e.g., a gNB) may configure two or more CLI resource (e.g., two or more CLI-RSSI or CLI-RSRP resources) for CLI measurement on two or more of the multiple non-contiguous downlink sub-bands of the SBFD TTI. In other words, the CLI reference signal 435 may occupy two or more CLI resources that are within two or more sub-bands of the set of non-contiguous sub-bands allocated for downlink communication. In some examples, each CLI resource may be within a respective sub-band of the set of non-contiguous sub-bands allocated for downlink communication.

In some other examples, the network entity 405-a (e.g., a gNB) may configure a single CLI resource (e.g., one CLI-RSSI or CLI-RSRP resource) for CLI measurement on two or more of the multiple non-contiguous downlink sub-bands of the SBFD TTI. In other words, the CLI reference signal 435 may occupy a CLI resource that is within two or more sub-bands of the set of non-contiguous sub-bands allocated for downlink communication. In some examples, the resource allocation information (e.g., indicated via the control information 430-a) may include a bitmap that indicates a distribution (e.g., a frequency location) of the CLI resource occupied by the CLI reference signal 435 across the set of non-contiguous sub-bands allocated for downlink communications. In some other examples, the resource allocation information (e.g., indicated via the control information 430-a) may indicate multiple resource block sets that include the CLI resource. In such examples, a resource block set (e.g., each resource block set) of the multiple resource block sets may be associated with a respective sub-band of the set of non-contiguous sub-bands allocated for downlink communication. In other words, the network entity 405-a (e.g., a gNB) may configure (e.g., explicitly) the CLI resource (e.g., one CLI-RSSI or CLI-RSRP resource) for CLI measurement on the two or more downlink sub-bands of the multiple non-contiguous downlink sub-bands of the SBFD TTI via a bitmap or via multiple non-contiguous downlink resource block sets.

In some other examples, the network entity 405-a (e.g., a gNB) may configure the CLI resource for CLI measurement on the two or more non-contiguous downlink sub-bands of the SBFD TTI symbols. In other words, the network entity 405-a may configure (e.g., implicitly) one CLI-RSSI or CLI-RSRP resource for CLI measurement on the two or more non-contiguous downlink sub-bands of the SBFD TTI symbols. That is, the UE 415-a may determine (e.g., implicitly) the CLI resource for CLI measurement on the two or more downlink sub-bands of the multiple non-contiguous downlink sub-bands of the SBFD TTI. In some examples, the UE 415-b may determine the CLI resource based on a semi-statically configured SBFD configuration of an uplink sub-band frequency location and one or more guard bands or the uplink sub-band frequency location and the downlink sub-band frequency location (e.g., within the set of frequency resources). In other words, the UE 415-b may receive a semi-static SBFD configuration (e.g., control information) that may indicate a respective frequency location of an uplink sub-band frequency location and one or more guard bands of the SBFD TTI or may indicate a respective frequency location of the uplink sub-band and one or more downlink sub-bands of the SBFD TTI. In such an example, the UE 415-b may determine (e.g., implicitly) the distribution of the CLI resource within the non-contiguous downlink sub-bands (e.g., within the set of frequency resources) based on the semi-statically configured SBFD configuration (e.g., and the set of frequency resources).

In other words, the CLI resource may be an example of a non-contiguous CLI resource that may be within two or more downlink sub-bands of the multiple non-contiguous downlink sub-bands of the SBFD TTI and the UE 415-b may determine the two or more downlink sub-bands (e.g., a frequency location of the two or more downlink sub-bands) based on a semi-statically configured SBFD frequency configuration. In such an example, the semi-statically configured SBFD frequency configuration may indicate a respective frequency location of an uplink sub-band and one or more guard bands. Alternatively, the semi-statically configured SBFD frequency configuration may indicate a respective frequency location of the uplink sub-band and the downlink sub-bands (e.g., explicitly). In other words, the CLI resource occupied by the CLI reference signal 435 may be within two or more sub-bands of the set of non-contiguous sub-bands allocated for downlink communication and the UE 415-b may measure CLI within a portion of the CLI resource. The portion of the CLI resource may be based on semi-static configuration information for SBFD operations (e.g., the semi-statically configured SBFD configuration) and the semi-static configuration information may be for a sub-band allocated for uplink communications (e.g., an uplink sub-band of the SBFD TTI) and one or more sub-bands of the set of non-contiguous sub-bands allocated for downlink communication (e.g., one or more downlink sub-bands of the SBFD TTI). Alternatively, the semi-static configuration information may be for the sub-band allocated for uplink communications (e.g., the uplink sub-band of the SBFD TTI) and one or more guard bands. In such examples, the report 440 may indicate information that may be indicative of the measured CLI. In some examples, the UE 415-b may receive second control information (e.g., the semi-static configuration information, the semi-statically configured SBFD frequency configuration) that indicates the frequency location of the sub-band allocated for uplink communication or the respective frequency location of the one or more guard bands.

In some examples, one or both of the network entities 405 and one or both of the UEs 415 may support non-contiguous CLI resource configurations for measuring CLI in multiple non-contiguous downlink sub-bands of the SBFD TTI. That is, one or both of the network entities 405 and one or both of the UEs 415 may support non-contiguous CLI resource configurations for measuring CLI in two or more non-contiguous downlink sub-bands for a SBFD symbol or slot. In such examples, the control information 430-a (e.g., a report configuration) may be linked to multiple CLI resources or resource sets (e.g., two different CLI resources or resource sets). That is, the resource allocation information (e.g., included in the control information 430-a) may indicate two CLI resource sets that include the one or more CLI resources occupied by the CLI reference signal 435. In such examples, a CLI resource set (e.g., each CLI resource set) of the two CLI resource sets may be associated with a respective sub-band of the set of non-contiguous sub-bands allocated for downlink communication.

In some other examples, the control information 430-a (e.g., a report configuration) may be linked to a single CLI resource or resource set. In such examples, the resource allocation information (e.g., included in the control information 430-a) may enable non-contiguous CLI resource configuration at the UE 415-b. That is, the single CLI resource or resource set may correspond to a CLI resource or CLI resource set that is within non-contiguous downlink sub-bands of the SBFD TTI. In some examples, the CLI resource or CLI resource set may be indicated via one or more resource block sets. For example, the resource allocation information may indicate a first (e.g., starting) resource block of the CLI resource set and a second (e.g., an ending, a last) resource block of one or more CLI resource sets. In some examples, the resource allocation information may indicate a respective pair of the first and second resource block for multiple sub-bands. That is, resource allocation information may indicate a respective starting and ending resource block for multiple sub-bands (e.g., each sub-band) of the set of non-contiguous sub-bands allocated for downlink communication. Additionally, or alternatively, the resource allocation information may indicate a quantity of resource blocks for one or multiple sub-bands. For example, the resource allocation information may indicate a respective quantity of resource blocks per sub-band of the set of non-contiguous sub-bands allocated for downlink communication.

In other words, a CLI resource set may include one or more resource block sets that includes the one or more CLI resources occupied by the CLI reference signal 435. Additionally, the one or more resource block sets (e.g., a CLI resource set) may be associated with the set of non-contiguous sub-bands allocated for downlink communication. In such an example, the resource allocation information may indicate the one or more resource block sets or the one or more CLI resources within the resource block sets or both. For example, the resource allocation information may include one or more bitmaps that indicate (e.g., explicitly) the one or more resource block sets. That is, the resource allocation information may indicate, via the one or more bitmaps, starting and ending resource blocks or a respective quantity of resource bocks per sub-band of the set of non-contiguous sub-bands allocated for downlink communication. In other words, the resource allocation information may include a bitmap that indicates the CLI resource set, or a bitmap that indicates the one or more CLI resources among the CLI resource set, or both. Additionally, or alternatively, the resource allocation information may indicate one or more resource block sets (e.g., via a starting and ending resource block or via a quantity of resource blocks per downlink sub-band) within the CLI resource set. In such an example, the one or more resource block sets include the one or more CLI resources occupied via the CLI reference signal 435. Additionally, in such an example, each resource block set may be associated with a respective sub-band of the set of non-contiguous sub-bands allocated for downlink communication.

In some other examples, the network entity 405-a (e.g., a gNB) may configure (e.g., implicitly) the one or more resource block sets for CLI measurement on the two or more non-contiguous downlink sub-bands of the SBFD TTI symbols. For example, the network entity 405-a may use a contiguous (e.g., relatively wideband) CLI resource configuration. That is, the network entity 405-a may indicate the contiguous CLI resource configuration (e.g., via the control information 430-a) to the UE 415-a. In such an example, the UE 415-a may determine (e.g., implicitly) the CLI resource based on the contiguous CLI resource configuration. For example, the UE 415-a may apply the contiguous (e.g., relatively wideband) CLI resource configuration in accordance with (e.g., based on) a semi-statically configured SBFD configuration of the uplink sub-band frequency location and one or more guard bands or the uplink sub-band frequency location and the downlink sub-band frequency location (e.g., within the set of frequency resources). In some examples, the UE 415-b may be configured with a rule for excluding CLI resources that may be within an uplink sub-band and guard bands or for excluding resource blocks outside of downlink sub-bands. In other words, the UE 415-b may measure CLI within one or more resource block sets included within the CLI resource set and the one or more resource block sets may include the one or more CLI resources occupied by the CLI reference signal 435. In such an example, the one or more resource block sets may be based on semi-static configuration information for SBFD operations. Additionally, in such an example, the semi-static configuration information may be for a sub-band allocated for uplink communications and one or more sub-bands of the set of non-contiguous sub-bands allocated for downlink communication or the semi-static configuration information may be for the sub-band allocated for uplink communications and one or more guard bands. In such examples, the information included in the report 440 may be indicative of the measured CLI. In some examples, transmitting the control information 430-a (or the control information 430-b) to the UE 415-b may enable CLI reporting for multiple types of TTIs, which may lead to increased communication reliability and reduced latency within the wireless communications system 400, among other benefits.

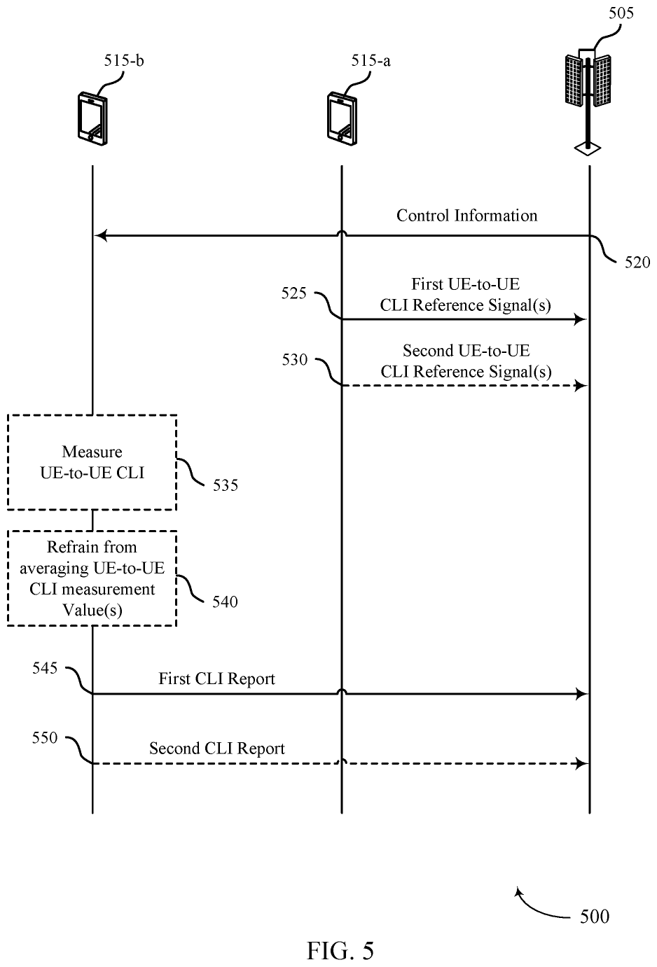

FIG. 5 shows an example of a process flow 500 that supports CLI reporting for multiple types of TTIs in accordance with one or more aspects of the present disclosure. The process flow 500 may implement or be implemented to facilitate or realize one or more aspects of the wireless communications system 100, the wireless communications system 200, the interference measurement diagram 300, and the wireless communications system 400. For example, the process flow 500 may be implemented at a UE 515-a and a UE 515-b, which may be examples of a UE illustrated by and described with reference to FIGS. 1 through 4. Additionally, the process flow 500 may be implemented at a network entity 505, which may be an example of a network entity illustrated by and described with reference to FIGS. 1 through 4. The operations performed at the UEs 515 (e.g., UE 515-a, UE 515-b) and the network entity 505 may support improvements to communications between the UEs 515 and the network entity 505, among other benefits. In the following description of the process flow 500, the operations performed at the UEs 515 and the network entity 505 may occur in a different order than the example order shown. Additionally, the operations performed at the UEs 515 and the network entity 505 may be performed at different times. Some operations may be combined and some operations may be omitted. In some examples, the UEs 515 and the network entity 505 may support a framework for UE-to-UE CLI measurement and reporting on multiple types of TTIs.

At 520, the UE 515-b may receive control information from the network entity 505. The control information may be an example of control information (e.g., a report configuration) illustrated by and described with reference to FIGS. 1 through 4. For example, the control information may indicate parameter information for reporting CLI. In some examples, the parameter information may include first parameter information for reporting CLI, which may be associated, in the control information, with a first type of TTI (e.g., may be associated with one of a SBFD TTI type, a non-SBFD TTI type, or a misaligned dynamic TDD TTI type).

At 525, the UE 515-b may receive a first one or more UE-to-UE CLI reference signals from the UE 515-a. The first one or more UE-to-UE CLI reference signals may each be an example of a CLI reference signal (e.g., a UE-to-UE CLI reference signal) illustrated by and described with reference to FIGS. 1 through 4. For example, the first one or more UE-to-UE CLI reference signals may each be an example of an uplink reference signal, such as an SRS. The UE 515-b may receive the first one or more UE-to-UE CLI reference signals during one or more TTIs of the first type of TTI.

In some examples, the parameter information (e.g., indicated via the control information received at 520) may include second parameter information for reporting CLI. The second parameter information may be associated, in the control information, with a second type of TTI. The second type of TTI may be different from the first type of TTI (e.g., may be a different one of the SBFD TTI type, the non-SBFD TTI type, or the misaligned dynamic TDD TTI type).

In such examples, at 530, the UE 515-b may receive a second one or more UE-to-UE CLI reference signals from the UE 515-b. The second one or more UE-to-UE CLI reference signals may each be an example of a CLI reference signal (e.g., a UE-to-UE CLI reference signal) illustrated by and described with reference to FIGS. 1 through 4. For example, the second one or more UE-to-UE CLI reference signals may each be an example of an uplink reference signal, such as an SRS. The UE 515-b may receive the second one or more UE-to-UE CLI reference signals during one or more TTIs of the second type of TTI.

In some examples, at 535, the UE 515-b may measure UE-to-UE CLI based on (e.g., using) the first one or more UE-to-UE CLI reference signals or the second one or more UE-to-UE CLI reference signals, or both. For example, the UE 515-b may generate information indicative of CLI (e.g., UE-to-UE CLI) experienced at the UE 515-b due to the first one or more UE-to-UE CLI reference signals or the second one or more UE-to-UE CLI reference signals, or both. In some examples, the information indicative of the CLI may be based on RSSI measurements or RSRP measurements performed on the first one or more UE-to-UE CLI reference signals or the second one or more UE-to-UE CLI reference signals, or both. That is, the information indicative of the CLI may indicate one or more CLI measurement values, which may include one or more values of an RSSI metric or one or more values of an RSRP metric.

At 545, the UE 515-b may transmit a first report including the information indicative of the CLI (e.g., the measured CLI). The information indicative of the CLI may be associated with the first one or more CLI reference signals or the second one or more CLI reference signals, or both. For example, the information indicative of the CLI (e.g., included in the first report) may be associated with the first type of TTI, the second type of TTI, or both the first type of TTI and the second type of TTI.

In some examples, at 540, the UE 515-b may refrain from averaging CLI measurement values across multiple (e.g., different) TTI types. Accordingly, the information indicative of the CLI (e.g., the information included first report transmitted at 545) may include first information associated with the first type of TTI and second information associated with the second type of TTI based on the refraining. The first information may include a first CLI measurement value that may be indicated as being associated with the first type of TTI and the second information may include a second CLI measurement value that may be indicated as being associated with the second type of TTI. That is, the first report may include multiple IEs or multiple fields that may indicate, to the network entity 505, that the first CLI measurement value is associated with the first type of TTI and the second CLI measurement value is associated with the second type of TTI. In some examples, first CLI measurement value may include a first value of a CLI metric and the second CLI measurement value may include a second value of the CLI metric (or another CLI metric). In such an example, the first value may be associated with the first type of TTI and the second value may be associated with the second type of TTI. In some other examples, based on the refraining, the UE 415-b may transmit multiple reports. For example, first report may include (e.g., only include) information indicative of the CLI that may be associated with the first type of TTI (e.g., the first report may only include the first information associated with the first type of TTI).

In such examples, at 550, the UE 515-b may transmit a second report including second information indicative of CLI that may be associate with the second type of TTI (e.g., the second report may only include the second information associated with the second type of TTI). In some examples, the second information indicative of the CLI (e.g., included in the second report) may be associated with the second one or more UE-to-UE CLI reference signals (e.g., only the second one or more UE-to-UE CLI reference signals). In some examples, the first report or the second report, or both, may enable CLI reporting for multiple types of TTIs, which may lead to increased communication reliability and reduced latency, among other benefits.

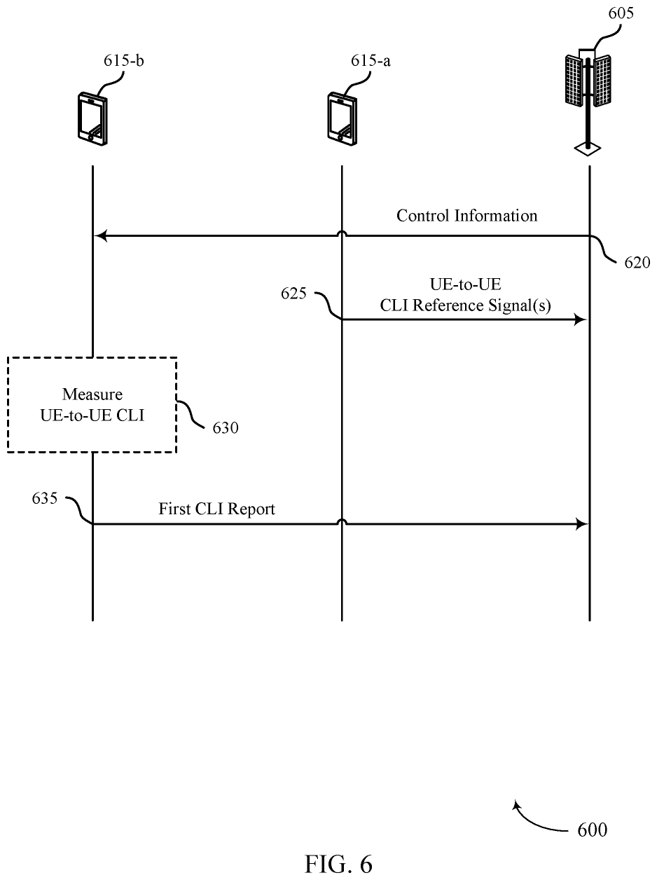

FIG. 6 shows an example of a process flow 600 that supports CLI reporting for multiple types of TTIs in accordance with one or more aspects of the present disclosure. The process flow 600 may implement or be implemented to facilitate or realize one or more aspects of the wireless communications system 100, the wireless communications system 200, the interference measurement diagram 300, the wireless communications system 400, and the process flow 500. For example, the process flow 600 may be implemented at a UE 615-a and a UE 615-b, which may be examples of a UE illustrated by and described with reference to FIGS. 1 through 5. Additionally, the process flow 600 may be implemented at a network entity 605, which may be an example of a network entity illustrated by and described with reference to FIGS. 1 through 5. The operations performed at the UEs 615 (e.g., UE 615-a, UE 615-b) and the network entity 605 may support improvements to communications between the UEs 615 and the network entity 605, among other benefits. In the following description of the process flow 600, the operations performed at the UEs 615 and the network entity 605 may occur in a different order than the example order shown. Additionally, the operations performed at the UEs 615 and the network entity 605 may be performed at different times. Some operations may be combined and some operations may be omitted. In some examples, the UEs 615 and the network entity 605 may support a framework for UE-to-UE CLI measurement and reporting on multiple types of TTIs.

At 620, the UE 615-b may receive control information from the network entity 605. The control information may be an example of control information (e.g., a report configuration) illustrated by and described with reference to FIGS. 1 through 5. For example, the control information may indicate resource allocation information for measuring CLI. In some examples, the resource allocation information may include a bitmap that indicates one or more CLI resources within a set of non-contiguous sub-bands allocated for downlink communications. Additionally, or alternatively, the resource allocation information may include a bitmap that indicates a distribution of one or more CLI resources across a set of non-contiguous sub-bands.

In some other examples, the resource allocation information may include information indicative of one or more resource block sets that include one or more CLI resources across the set of non-contiguous sub-bands. For example, each resource block set may be associated with a respective sub-band of the set of non-contiguous sub-bands allocated for downlink communication. In some examples, the resource allocation information may indicate one or more resource block sets within a CLI resource set. In such examples, the one or more resource block sets may include the one or more CLI resources.

At 625, the UE 615-b may receive one or more UE-to-UE CLI reference signals from the UE 615-a via the one or more CLI resources in accordance with the resource allocation information. For example, the one or more CLI resources may be within one or more sub-bands of the set of non-contiguous sub-bands allocated for downlink communication. The one or more UE-to-UE CLI reference signals may each be an example of a CLI reference signal (e.g., a UE-to-UE CLI reference signal) illustrated by and described with reference to FIGS. 1 through 5. For example, the one or more UE-to-UE CLI reference signals may each be an example of an uplink reference signal, such as an SRS.

In some examples, at 630, the UE 615-b may measure UE-to-UE CLI based on (e.g., using) the one or more UE-to-UE CLI reference signals. For example, the UE 515-b may generate information indicative of CLI (e.g., UE-to-UE CLI) experienced at the UE 615-b due to the one or more UE-to-UE CLI reference signals. In some examples, the information indicative of the CLI may be based on RSSI measurements or RSRP measurements performed on the one or more UE-to-UE CLI reference signals. That is, the information indicative of the CLI may be indicative of the CLI measured at 630. For example, the information indicative of the CLI may indicate one or more CLI measurement values, which may include one or more values of an RSSI metric or one or more values of an RSRP metric.

In some examples, the UE 615-b may measure CLI (e.g., at 630) within a portion of the CLI resource (e.g., occupied by the one or more UE-to-UE CLI reference signals). In such examples, the portion may be based on semi-static configuration information for SBFD operations. For example, the semi-state configuration information may be for a sub-band allocated for uplink communications and one or more sub-bands of the set of non-contiguous sub-bands allocated for downlink communication. In some other examples, the semi-static configuration information may be for the sub-band allocated for uplink communications and one or more guard bands.

In some other examples, the UE 615-b may measure CLI (e.g., at 630) within one or more resource block sets of a CLI resource set. In such examples, the one or more resource block sets may include the one or more CLI resources (e.g., occupied by the one or more UE-to-UE CLI reference signals). The UE 615-b may determine the one or more resource block sets based on the semi-static configuration information for SBFD operations. That is, the UE 615-b may determine the one or more resource block sets based on semi-state configuration information for a sub-band allocated for uplink communications and one or more sub-bands of the set of non-contiguous sub-bands allocated for downlink communication or based on semi-static configuration information for the sub-band allocated for uplink communications and one or more guard bands.

At 635, the UE 615-b may transmit a report including the information indicative of the CLI (e.g., the measured CLI). The report may be an example of a report illustrated by and described with reference to FIGS. 1 through 5. For example, the information indicative of the CLI, which may be included in the report, may be associated with the one or more CLI reference signals. In some examples, the report may enable CLI reporting for non-contiguous sub-bands of a SBFD TTI, which may lead to increased communication reliability and reduced latency, among other benefits.

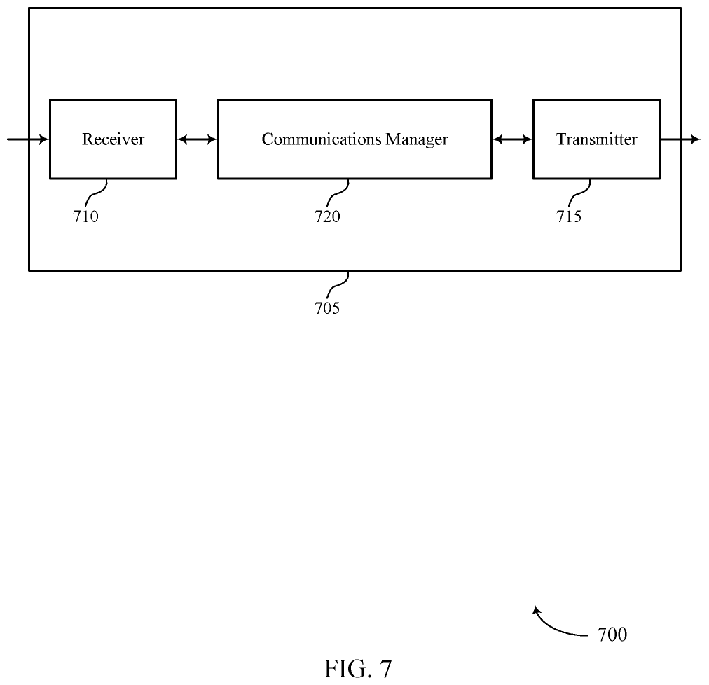

FIG. 7 shows a block diagram 700 of a device 705 that supports CLI reporting for multiple types of TTIs in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to CLI reporting for multiple types of TTIs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to CLI reporting for multiple types of TTIs). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of CLI reporting for multiple types of TTIs as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first network entity (e.g., the device 705) in accordance with examples as disclosed herein. For example, the communications manager 720 is capable of, configured to, or operable to support a means for receiving control information that indicates parameter information for reporting CLI, where the parameter information includes first parameter information for reporting CLI, and where the first parameter information is associated, in the control information, with a first type of TTI. The communications manager 720 is capable of, configured to, or operable to support a means for receiving one or more CLI reference signals during one or more TTIs of the first type of TTI. The communications manager 720 is capable of, configured to, or operable to support a means for transmitting a report including information indicative of CLI, where the information indicative of the CLI is associated with the one or more CLI reference signals.

Additionally, or alternatively, the communications manager 720 may support wireless communication at a first network entity (e.g., the device 705) in accordance with examples as disclosed herein. For example, the communications manager 720 is capable of, configured to, or operable to support a means for receiving control information that indicates resource allocation information for measuring CLI. The communications manager 720 is capable of, configured to, or operable to support a means for receiving one or more CLI reference signals via one or more CLI resources in accordance with the resource allocation information, where the one or more CLI resources are within one or more sub-bands of a set of non-contiguous sub-bands allocated for downlink communication. The communications manager 720 is capable of, configured to, or operable to support a means for transmitting a report including information indicative of CLI, where the information indicative of the CLI is associated with the one or more CLI reference signals.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

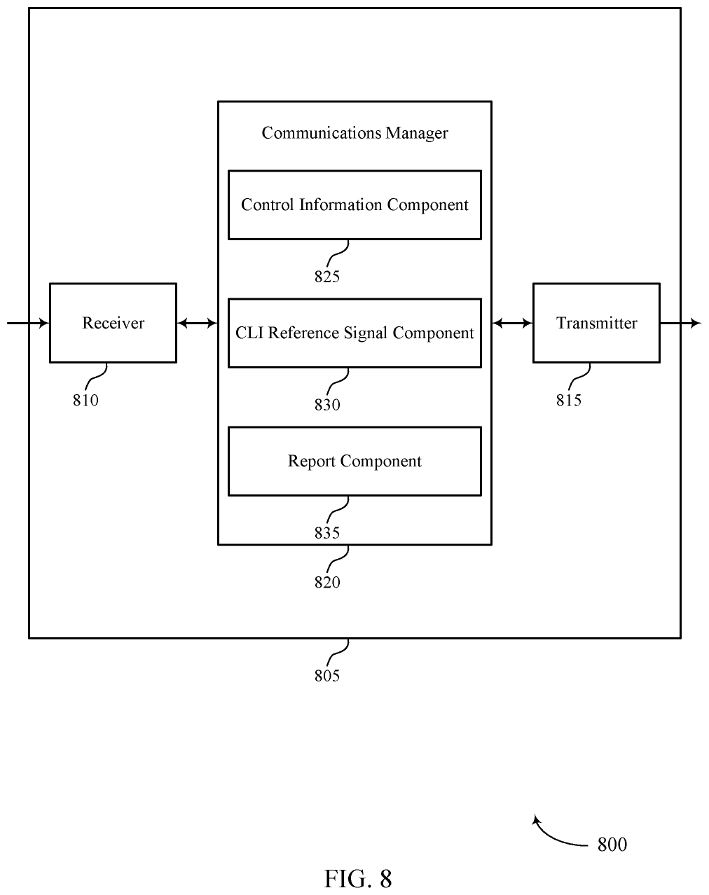

FIG. 8 shows a block diagram 800 of a device 805 that supports CLI reporting for multiple types of TTIs in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to CLI reporting for multiple types of TTIs). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to CLI reporting for multiple types of TTIs). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of CLI reporting for multiple types of TTIs as described herein. For example, the communications manager 820 may include a control information component 825, a CLI reference signal component 830, a report component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first network entity (e.g., the device 805) in accordance with examples as disclosed herein. The control information component 825 is capable of, configured to, or operable to support a means for receiving control information that indicates parameter information for reporting CLI, where the parameter information includes first parameter information for reporting CLI, and where the first parameter information is associated, in the control information, with a first type of TTI. The CLI reference signal component 830 is capable of, configured to, or operable to support a means for receiving one or more CLI reference signals during one or more TTIs of the first type of TTI. The report component 835 is capable of, configured to, or operable to support a means for transmitting a report including information indicative of CLI, where the information indicative of the CLI is associated with the one or more CLI reference signals.

Additionally, or alternatively, the communications manager 820 may support wireless communication at a first network entity (e.g., the device 805) in accordance with examples as disclosed herein. The control information component 825 is capable of, configured to, or operable to support a means for receiving control information that indicates resource allocation information for measuring CLI. The CLI reference signal component 830 is capable of, configured to, or operable to support a means for receiving one or more CLI reference signals via one or more CLI resources in accordance with the resource allocation information, where the one or more CLI resources are within one or more sub-bands of a set of non-contiguous sub-bands allocated for downlink communication. The report component 835 is capable of, configured to, or operable to support a means for transmitting a report including information indicative of CLI, where the information indicative of the CLI is associated with the one or more CLI reference signals.

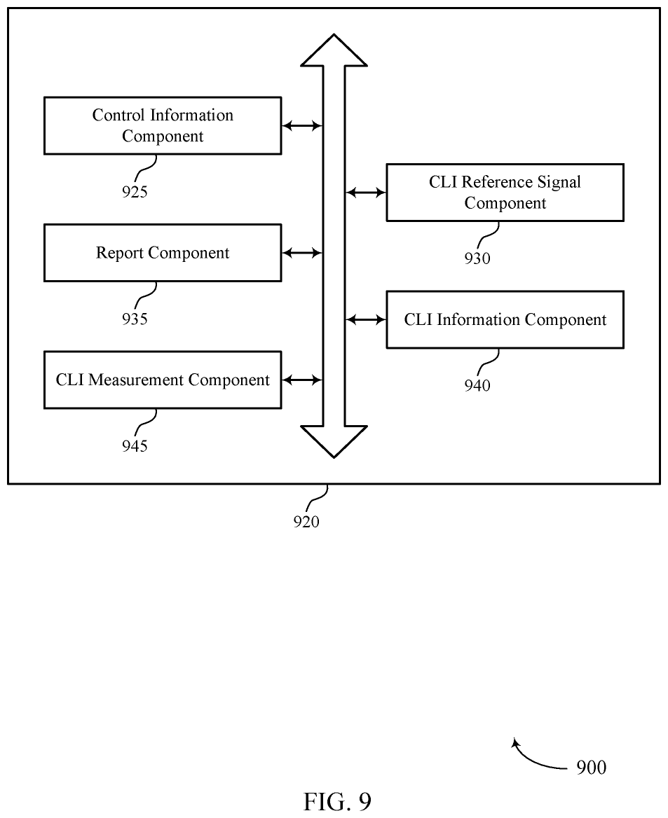

FIG. 9 shows a block diagram 900 of a communications manager 920 that supports CLI reporting for multiple types of TTIs in accordance with one or more aspects of the present disclosure. The communications manager 920 may be an example of aspects of a communications manager 720, a communications manager 820, or both, as described herein. The communications manager 920, or various components thereof, may be an example of means for performing various aspects of CLI reporting for multiple types of TTIs as described herein. For example, the communications manager 920 may include a control information component 925, a CLI reference signal component 930, a report component 935, a CLI information component 940, a CLI measurement component 945, or any combination thereof. Each of these components, or components or subcomponents thereof (e.g., one or more processors, one or more memories), may communicate, directly or indirectly, with one another (e.g., via one or more buses).

The communications manager 920 may support wireless communication at a first network entity in accordance with examples as disclosed herein. The control information component 925 is capable of, configured to, or operable to support a means for receiving control information that indicates parameter information for reporting CLI, where the parameter information includes first parameter information for reporting CLI, and where the first parameter information is associated, in the control information, with a first type of TTI. The CLI reference signal component 930 is capable of, configured to, or operable to support a means for receiving one or more CLI reference signals during one or more TTIs of the first type of TTI. The report component 935 is capable of, configured to, or operable to support a means for transmitting a report including information indicative of CLI, where the information indicative of the CLI is associated with the one or more CLI reference signals.

In some examples, the parameter information includes second parameter information for reporting CLI. In some examples, the second parameter information is associated, in the control information, with a second type of TTI. In some examples, the second type of TTI is different from the first type of TTI. In some examples, the control information indicates a first set of CLI resources associated with the first type of TTI and a second set of CLI resources associated with the second type of TTI.

In some examples, the one or more CLI reference signals are received during at least one CLI reference signal of the first set of CLI resources. In some examples, the information indicative of the CLI is associated with only the first type of TTI.

In some examples, the CLI reference signal component 930 is capable of, configured to, or operable to support a means for receiving a second one or more CLI reference signals during one or more TTIs of the second type of TTI. In some examples, the report component 935 is capable of, configured to, or operable to support a means for transmitting a second report including second information indicative of CLI, where the second information indicative of the CLI is associated with only the second one or more CLI reference signals. In some examples, the information indicative of the CLI is associated with both the first type of TTI and the second type of TTI.

In some examples, the CLI information component 940 is capable of, configured to, or operable to support a means for refraining from averaging CLI measurement values across different TTI types, where the information indicative of the CLI includes first information associated with the first type of TTI and second information associated with the second type of TTI based on the refraining.

In some examples, the first information includes a first CLI measurement value that is indicated as being associated with the first type of TTI. In some examples, the second information includes a second CLI measurement value that is indicated as being associated with the second type of TTI. In some examples, first CLI measurement value includes a first value of a CLI metric and the second CLI measurement value includes a second value of the CLI metric. In some examples, the first value is associated with the first type of TTI and the second value is associated with the second type of TTI.

In some examples, the first type of TTI includes an SBFD TTI type, a non-SBFD TTI type, a misaligned dynamic TDD TTI type, an aligned dynamic TDD TTI type, or a non-SBFD misaligned dynamic TDD TTI type. In some examples, the CLI information component 940 is capable of, configured to, or operable to support a means for generating, based on the one or more CLI reference signals, the information indicative of the CLI.

In some examples, to support receiving the control information, the control information component 925 is capable of, configured to, or operable to support a means for receiving the control information via a CLI report configuration message or a CSI report configuration message. In some examples, the control information indicates a minimum quantity of TTIs between a reporting TTI in which the report is to be transmitted and a reference TTI. In some examples, the minimum quantity of TTIs includes TTIs of any type. In some examples, the control information indicates a minimum quantity of TTIs between a reporting TTI in which the report is to be transmitted and a reference TTI. In some examples, the minimum quantity of TTIs includes TTIs of only the first type.

In some examples, the first type of TTI includes a type of slot or a type of symbol. In some examples, the first network entity includes a UE. In some examples, the one or more CLI reference signals include UE-to-UE CLI reference signals. In some examples, the information indicative of CLI includes information indicative of UE-to-UE CLI. In some examples, the first parameter information is for reporting CLI that is associated with a half-duplex operation mode at the first network entity.

In some examples, to support receiving the control information, the control information component 925 is capable of, configured to, or operable to support a means for receiving the control information from a second network entity, where the first parameter information is for reporting CLI that is associated with a full-duplex operation mode at the second network entity.

In some examples, to support receiving the control information, the control information component 925 is capable of, configured to, or operable to support a means for receiving the control information from a second network entity, where the first parameter information is for reporting CLI that is associated with a sub-band full-duplex operation mode at the second network entity.

In some examples, to support receiving the control information, the control information component 925 is capable of, configured to, or operable to support a means for receiving the control information from a second network entity, where the first parameter information is for reporting CLI that is associated with a half-duplex operation mode at the second network entity and with a misaligned TTI format.

In some examples, the parameter information includes information indicative of at least one parameter for measuring or reporting CLI. In some examples, the at least one parameter includes a type of CLI metric to be reported, one or more resources for measuring CLI, or one or more resources for reporting CLI. In some examples, the type of CLI metric includes a RSRP metric type or a RSSI metric type. In some examples, the control information includes an indication that the first parameter information is applicable to TTIs of the first type of TTI.

Additionally, or alternatively, the communications manager 920 may support wireless communication at a first network entity in accordance with examples as disclosed herein. In some examples, the control information component 925 is capable of, configured to, or operable to support a means for receiving control information that indicates resource allocation information for measuring CLI. In some examples, the CLI reference signal component 930 is capable of, configured to, or operable to support a means for receiving one or more CLI reference signals via one or more CLI resources in accordance with the resource allocation information, where the one or more CLI resources are within one or more sub-bands of a set of non-contiguous sub-bands allocated for downlink communication. In some examples, the report component 935 is capable of, configured to, or operable to support a means for transmitting a report including information indicative of CLI, where the information indicative of the CLI is associated with the one or more CLI reference signals.

In some examples, the one or more CLI resources includes a CLI resource that is within one sub-band of the set of non-contiguous sub-bands allocated for downlink communication. In some examples, the one or more CLI resources includes two CLI resources. In some examples, each CLI resource of the two CLI resources is within a respective sub-band of the set of non-contiguous sub-bands allocated for downlink communication.

In some examples, the one or more CLI resources includes a CLI resource that is within at least two sub-bands of the set of non-contiguous sub-bands allocated for downlink communication. In some examples, the resource allocation information includes a bitmap that indicates a distribution of the CLI resource across the set of non-contiguous sub-bands.

In some examples, the resource allocation information indicates a set of multiple resource block sets that include the CLI resource. In some examples, each resource block set of the set of multiple resource block sets is associated with a respective sub-band of the set of non-contiguous sub-bands allocated for downlink communication.

In some examples, the one or more CLI resources include a CLI resource that is within the set of non-contiguous sub-bands allocated for downlink communication, and the CLI measurement component 945 is capable of, configured to, or operable to support a means for measuring CLI within a portion of the CLI resource, where the portion is based on semi-static configuration information for SBFD operations, where the semi-static configuration information is for a sub-band allocated for uplink communications and one or more sub-bands of the set of non-contiguous sub-bands allocated for downlink communication or the semi-static configuration information is for the sub-band allocated for uplink communications and one or more guard bands, and where the information is indicative of the measured CLI.

In some examples, the control information component 925 is capable of, configured to, or operable to support a means for receiving second control information that indicates a frequency location of the sub-band allocated for uplink communication or a respective frequency location of the one or more guard bands.

In some examples, the resource allocation information indicates two CLI resource sets that include the one or more CLI resources. In some examples, each CLI resource set of the two CLI resource sets is associated with a respective sub-band of the set of non-contiguous sub-bands allocated for downlink communication.

In some examples, the resource allocation information indicates a CLI resource set that includes the one or more CLI resources. In some examples, the CLI resource set is associated with the set of non-contiguous sub-bands allocated for downlink communication. In some examples, the resource allocation information includes a bitmap that indicates the one or more CLI resources.

In some examples, the resource allocation information indicates one or more resource block sets within the CLI resource set. In some examples, the one or more resource block sets include the one or more CLI resources. In some examples, each resource block set is associated with a respective sub-band of the set of non-contiguous sub-bands allocated for downlink communication.

In some examples, the CLI measurement component 945 is capable of, configured to, or operable to support a means for measuring CLI within one or more resource block sets within the CLI resource set, where the one or more resource block sets include the one or more CLI resources, where the one or more resource block sets are based on semi-static configuration information for SBFD operations, where the semi-static configuration information is for a sub-band allocated for uplink communications and one or more sub-bands of the set of non-contiguous sub-bands allocated for downlink communication or the semi-static configuration information is for the sub-band allocated for uplink communications and one or more guard bands, and where the information is indicative of the measured CLI.

In some examples, the set of non-contiguous sub-bands allocated for downlink communication are within a TTI allocated for SBFD operations at a second network entity. In some examples, the first network entity includes a UE and the second network entity includes a base station.

In some examples, the one or more CLI reference signals include UE-to-UE CLI reference signals. In some examples, the resource allocation information is for measuring UE-to-UE CLI. In some examples, the resource allocation information is for measuring CLI that is associated with a half-duplex operation mode at the first network entity.

In some examples, to support receiving the control information, the control information component 925 is capable of, configured to, or operable to support a means for receiving the control information from a second network entity, where the resource allocation information is for measuring CLI that is associated with a full-duplex operation mode at the second network entity.

In some examples, to support receiving the control information, the control information component 925 is capable of, configured to, or operable to support a means for receiving the control information from a second network entity, where the resource allocation information is for measuring CLI that is associated with a SBFD operation mode at the second network entity.

In some examples, to support receiving the control information, the control information component 925 is capable of, configured to, or operable to support a means for receiving the control information from a second network entity, where the resource allocation information is for measuring CLI that is associated with a half-duplex operation mode at the second network entity and with a misaligned TTI format.

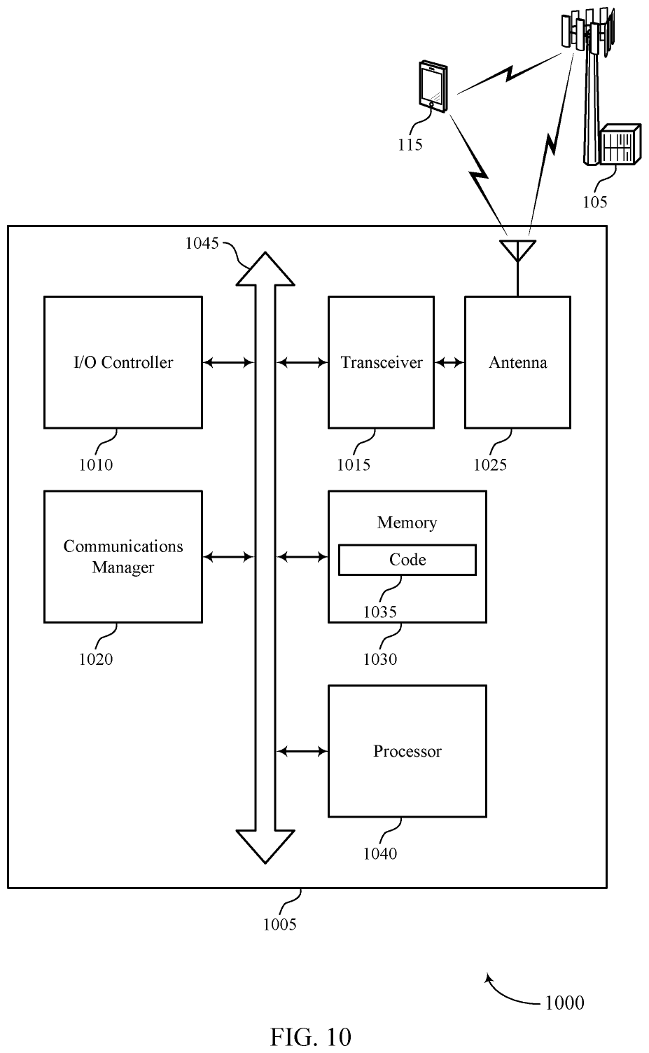

FIG. 10 shows a diagram of a system 1000 including a device 1005 that supports CLI reporting for multiple types of TTIs in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting CLI reporting for multiple types of TTIs). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein.

The communications manager 1020 may support wireless communication at a first network entity in accordance with examples as disclosed herein. For example, the communications manager 1020 is capable of, configured to, or operable to support a means for receiving control information that indicates parameter information for reporting CLI, where the parameter information includes first parameter information for reporting CLI, and where the first parameter information is associated, in the control information, with a first type of TTI. The communications manager 1020 is capable of, configured to, or operable to support a means for receiving one or more CLI reference signals during one or more TTIs of the first type of TTI. The communications manager 1020 is capable of, configured to, or operable to support a means for transmitting a report including information indicative of CLI, where the information indicative of the CLI is associated with the one or more CLI reference signals.

Additionally, or alternatively, the communications manager 1020 may support wireless communication at a first network entity in accordance with examples as disclosed herein. For example, the communications manager 1020 is capable of, configured to, or operable to support a means for receiving control information that indicates resource allocation information for measuring CLI. The communications manager 1020 is capable of, configured to, or operable to support a means for receiving one or more CLI reference signals via one or more CLI resources in accordance with the resource allocation information, where the one or more CLI resources are within one or more sub-bands of a set of non-contiguous sub-bands allocated for downlink communication. The communications manager 1020 is capable of, configured to, or operable to support a means for transmitting a report including information indicative of CLI, where the information indicative of the CLI is associated with the one or more CLI reference signals.

By including or configuring the communications manager 1020 in accordance with examples as described herein, the device 1005 may support techniques for improved communication reliability, reduced latency, and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of CLI reporting for multiple types of TTIs as described herein, or the at least one processor 1040 and the at least one memory 1030 may be otherwise configured to, individually or collectively, perform or support such operations.

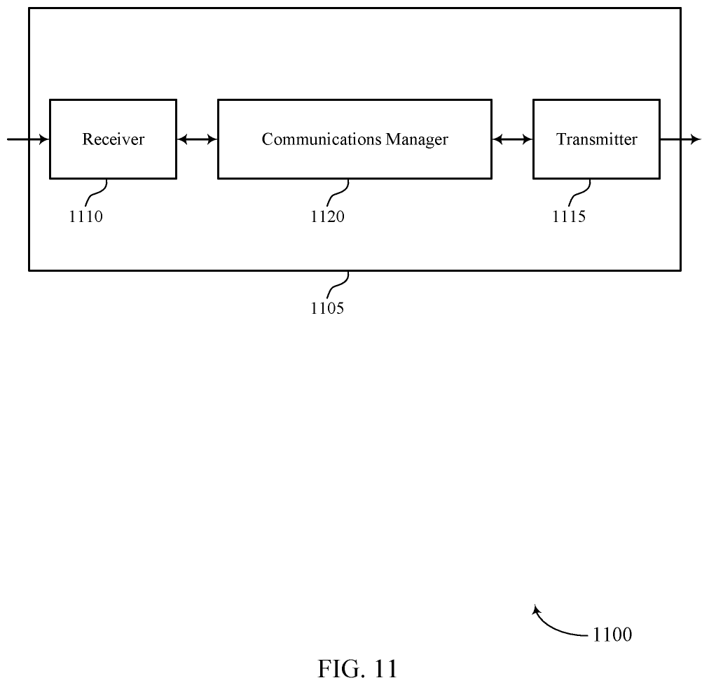

FIG. 11 shows a block diagram 1100 of a device 1105 that supports CLI reporting for multiple types of TTIs in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of CLI reporting for multiple types of TTIs as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a first network entity (e.g., the device 1105) in accordance with examples as disclosed herein. For example, the communications manager 1120 is capable of, configured to, or operable to support a means for outputting control information that indicates parameter information for reporting CLI, where the parameter information includes first parameter information for reporting CLI, and where the first parameter information is associated, in the control information, with a first type of TTI. The communications manager 1120 is capable of, configured to, or operable to support a means for obtaining a report including information indicative of CLI, where the information indicative of the CLI is associated with one or more CLI resources that are within one or more TTIs of the first type of TTI.

Additionally, or alternatively, the communications manager 1120 may support wireless communication at a first network entity (e.g., the device 1105) in accordance with examples as disclosed herein. For example, the communications manager 1120 is capable of, configured to, or operable to support a means for outputting control information that indicates resource allocation information for measuring CLI. The communications manager 1120 is capable of, configured to, or operable to support a means for obtaining a report including information indicative of CLI, where the information indicative of the CLI is associated within one or more CLI resources in accordance with the resource allocation information, and where the one or more CLI resources are within one or more sub-bands of a set of non-contiguous sub-bands allocated for downlink communication.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources.

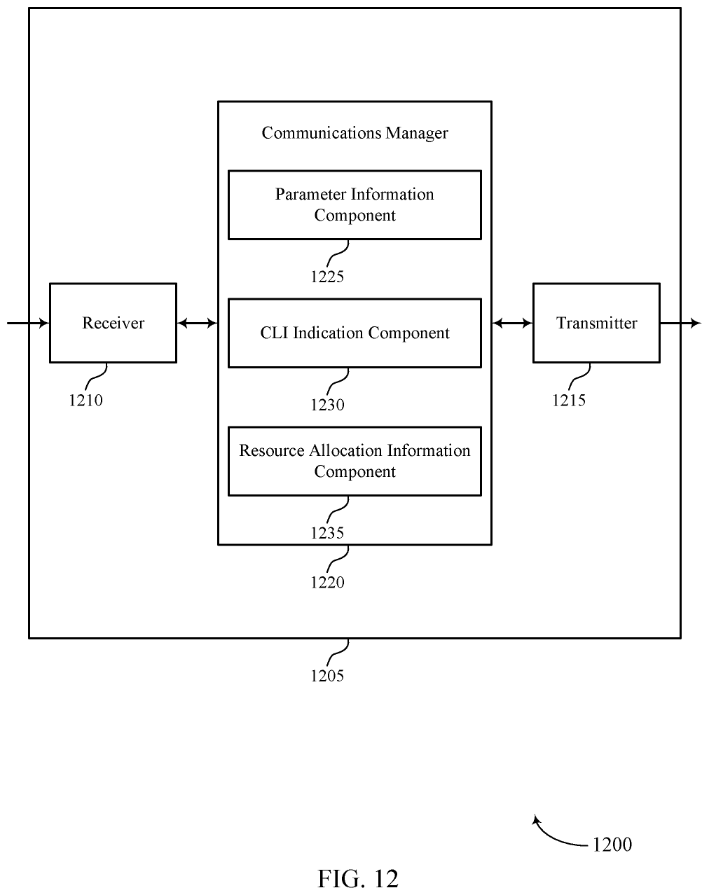

FIG. 12 shows a block diagram 1200 of a device 1205 that supports CLI reporting for multiple types of TTIs in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of CLI reporting for multiple types of TTIs as described herein. For example, the communications manager 1220 may include a parameter information component 1225, a CLI indication component 1230, a resource allocation information component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a first network entity (e.g., the device 1205) in accordance with examples as disclosed herein. The parameter information component 1225 is capable of, configured to, or operable to support a means for outputting control information that indicates parameter information for reporting CLI, where the parameter information includes first parameter information for reporting CLI, and where the first parameter information is associated, in the control information, with a first type of TTI. The CLI indication component 1230 is capable of, configured to, or operable to support a means for obtaining a report including information indicative of CLI, where the information indicative of the CLI is associated with one or more CLI resources that are within one or more TTIs of the first type of TTI.

Additionally, or alternatively, the communications manager 1220 may support wireless communication at a first network entity (e.g., the device 1205) in accordance with examples as disclosed herein. The resource allocation information component 1235 is capable of, configured to, or operable to support a means for outputting control information that indicates resource allocation information for measuring CLI. The CLI indication component 1230 is capable of, configured to, or operable to support a means for obtaining a report including information indicative of CLI, where the information indicative of the CLI is associated within one or more CLI resources in accordance with the resource allocation information, and where the one or more CLI resources are within one or more sub-bands of a set of non-contiguous sub-bands allocated for downlink communication.

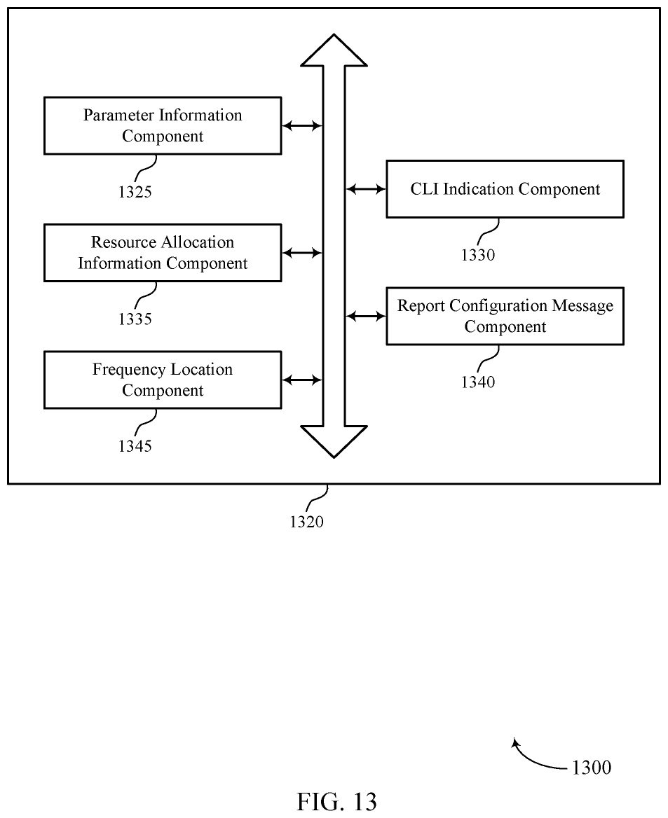

FIG. 13 shows a block diagram 1300 of a communications manager 1320 that supports CLI reporting for multiple types of TTIs in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of CLI reporting for multiple types of TTIs as described herein. For example, the communications manager 1320 may include a parameter information component 1325, a CLI indication component 1330, a resource allocation information component 1335, a report configuration message component 1340, a frequency location component 1345, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a first network entity in accordance with examples as disclosed herein. The parameter information component 1325 is capable of, configured to, or operable to support a means for outputting control information that indicates parameter information for reporting CLI, where the parameter information includes first parameter information for reporting CLI, and where the first parameter information is associated, in the control information, with a first type of TTI. The CLI indication component 1330 is capable of, configured to, or operable to support a means for obtaining a report including information indicative of CLI, where the information indicative of the CLI is associated with one or more CLI resources that are within one or more TTIs of the first type of TTI.

In some examples, the parameter information includes second parameter information for reporting CLI. In some examples, the second parameter information is associated, in the control information, with a second type of TTI. In some examples, the second type of TTI is different from the first type of TTI. In some examples, the control information indicates a first set of CLI resources associated with the first type of TTI and a second set of CLI resources associated with the second type of TTI.

In some examples, the first set of CLI resources includes the one or more CLI resources. In some examples, the information indicative of the CLI is associated with only the first type of TTI.

In some examples, the CLI indication component 1330 is capable of, configured to, or operable to support a means for obtaining a second report including second information indicative of CLI, where the second information indicative of the CLI is associated with only a second one or more CLI resources that are within one or more TTIs of the second type of TTI.

In some examples, the information indicative of the CLI is associated with both the first type of TTI and the second type of TTI. In some examples, the information indicative of the CLI includes first information associated with the first type of TTI and second information associated with the second type of TTI.

In some examples, the first information includes a first CLI measurement value that is indicated as being associated with the first type of TTI. In some examples, the second information includes a second CLI measurement value that is indicated as being associated with the second type of TTI.

In some examples, first CLI measurement value includes a first value of a CLI metric and the second CLI measurement value includes a second value of the CLI metric. In some examples, the first value is associated with the first type of TTI and the second value is associated with the second type of TTI.

In some examples, the first type of TTI includes a SBFD TTI type, a non-SBFD TTI type, a misaligned dynamic TDD TTI type, an aligned dynamic TDD TTI type, or a non-SBFD misaligned dynamic TDD TTI type. In some examples, the first type of TTI includes a type of slot or a type of symbol.

In some examples, to support outputting the control information, the report configuration message component 1340 is capable of, configured to, or operable to support a means for outputting the control information via a CLI report configuration message or a CSI report configuration message.

In some examples, the control information indicates a minimum quantity of TTIs between a reporting TTI in which the report is to be transmitted and a reference TTI. In some examples, the minimum quantity of TTIs includes TTIs of any type.

In some examples, the control information indicates a minimum quantity of TTIs between a reporting TTI in which the report is to be transmitted and a reference TTI. In some examples, the minimum quantity of TTIs includes TTIs of only the first type. In some examples, the first type of TTI includes a type of slot or a type of symbol. In some examples, the information indicative of CLI includes information indicative of UE-to-UE CLI.

In some examples, to support outputting the control information, the parameter information component 1325 is capable of, configured to, or operable to support a means for outputting the control information to a second network entity, where the first parameter information is for reporting CLI that is associated with a half-duplex operation mode at the second network entity.

In some examples, the first parameter information is for reporting CLI that is associated with a full-duplex operation mode at the first network entity. In some examples, the first parameter information is for reporting CLI that is associated with a SBFD operation mode at the first network entity. In some examples, the first parameter information is for reporting CLI that is associated with a half-duplex operation mode at the first network entity and with a misaligned TTI format.

In some examples, to support outputting the control information, the parameter information component 1325 is capable of, configured to, or operable to support a means for outputting the control information to a second network entity, where the first parameter information is indicative of at least one parameter for measuring or reporting CLI.

In some examples, the at least one parameter includes a type of CLI metric to be reported, one or more resources for measuring CLI, or one or more resources for reporting CLI. In some examples, the type of CLI metric includes a RSRP metric type or a RSSI metric type. In some examples, the control information includes an indication that the first parameter information is applicable to TTIs of the first type of TTI.

Additionally, or alternatively, the communications manager 1320 may support wireless communication at a first network entity in accordance with examples as disclosed herein. The resource allocation information component 1335 is capable of, configured to, or operable to support a means for outputting control information that indicates resource allocation information for measuring CLI. In some examples, the CLI indication component 1330 is capable of, configured to, or operable to support a means for obtaining a report including information indicative of CLI, where the information indicative of the CLI is associated within one or more CLI resources in accordance with the resource allocation information, and where the one or more CLI resources are within one or more sub-bands of a set of non-contiguous sub-bands allocated for downlink communication.

In some examples, the one or more CLI resources includes a CLI resource that is within one sub-band of the set of non-contiguous sub-bands allocated for downlink communication. In some examples, the one or more CLI resources includes two CLI resources. In some examples, each CLI resource of the two CLI resources is within a respective sub-band of the set of non-contiguous sub-bands allocated for downlink communication. In some examples, the one or more CLI resources includes a CLI resource that is within at least two sub-bands of the set of non-contiguous sub-bands allocated for downlink communication.

In some examples, the resource allocation information includes a bitmap that indicates a distribution of the CLI resource across the set of non-contiguous sub-bands. In some examples, the resource allocation information indicates a set of multiple resource block sets that include the CLI resource. In some examples, each resource block set of the set of multiple resource block sets is associated with a respective sub-band of the set of non-contiguous sub-bands allocated for downlink communication.

In some examples, the one or more CLI resources include a CLI resource that is within the set of non-contiguous sub-bands allocated for downlink communication. In some examples, the information is indicative of CLI measured within a portion of the CLI resource that is based on semi-static configuration information for SBFD operations. In some examples, the semi-static configuration information is for a sub-band allocated for uplink communications and one or more sub-bands of the set of non-contiguous sub-bands allocated for downlink communication or the semi-static configuration information is for the sub-band allocated for uplink communications and one or more guard bands.

In some examples, the frequency location component 1345 is capable of, configured to, or operable to support a means for outputting second control information that indicates a frequency location of the sub-band allocated for uplink communication or a respective frequency location of the one or more guard bands.

In some examples, the resource allocation information indicates two CLI resource sets that include the one or more CLI resources. In some examples, each CLI resource set of the two CLI resource sets is associated with a respective sub-band of the set of non-contiguous sub-bands allocated for downlink communication.

In some examples, the resource allocation information indicates a CLI resource set that includes the one or more CLI resources. In some examples, the CLI resource set is associated with the set of non-contiguous sub-bands allocated for downlink communication.

In some examples, the resource allocation information includes a bitmap that indicates the one or more CLI resources. In some examples, the resource allocation information indicates one or more resource block sets within the CLI resource set. In some examples, the one or more resource block sets include the one or more CLI resources. In some examples, each resource block set is associated with a respective sub-band of the set of non-contiguous sub-bands allocated for downlink communication.

In some examples, the information is indicative of CLI measured within one or more resource block sets within the CLI resource set. In some examples, the one or more resource block sets include the one or more CLI resources. In some examples, the one or more resource block sets are based on semi-static configuration information for SBFD operations. In some examples, the semi-static configuration information is for a sub-band allocated for uplink communications and one or more sub-bands of the set of non-contiguous sub-bands allocated for downlink communication or the semi-static configuration information is for the sub-band allocated for uplink communications and one or more guard bands.

In some examples, the set of non-contiguous sub-bands allocated for downlink communication are within a TTI allocated for SBFD operations at the first network entity. In some examples, the first network entity includes a base station.

In some examples, to support outputting the control information, the resource allocation information component 1335 is capable of, configured to, or operable to support a means for outputting the control information to a second network entity that includes a UE, where the resource allocation information is for measuring UE-to-UE CLI.

In some examples, to support outputting the control information, the resource allocation information component 1335 is capable of, configured to, or operable to support a means for outputting the control information to a second network entity, where the resource allocation information is for measuring CLI that is associated with a half-duplex operation mode at the second network entity. In some examples, the resource allocation information is for measuring CLI that is associated with a full-duplex operation mode at the first network entity.

In some examples, the resource allocation information is for measuring CLI that is associated with a SBFD operation mode at the first network entity. In some examples, the resource allocation information is for measuring CLI that is associated with a half-duplex operation mode at the first network entity and with a misaligned TTI format.

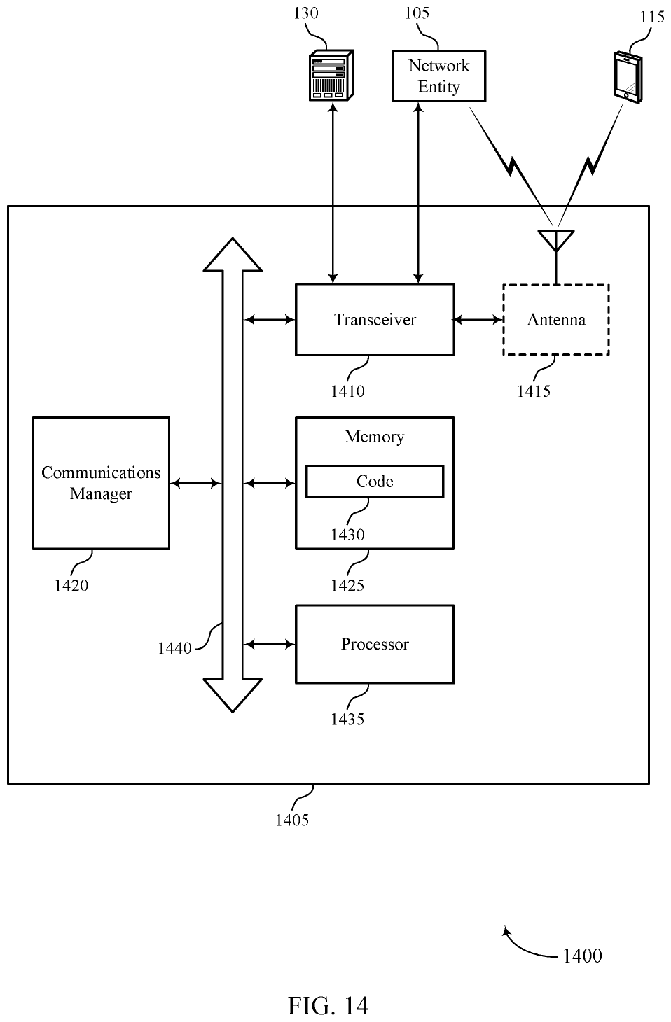

FIG. 14 shows a diagram of a system 1400 including a device 1405 that supports CLI reporting for multiple types of TTIs in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting CLI reporting for multiple types of TTIs). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some implementations, the at least one processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the at least one processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with ULEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a first network entity (e.g., the device 1405) in accordance with examples as disclosed herein. For example, the communications manager 1420 is capable of, configured to, or operable to support a means for outputting control information that indicates parameter information for reporting CLI, where the parameter information includes first parameter information for reporting CLI, and where the first parameter information is associated, in the control information, with a first type of TTI. The communications manager 1420 is capable of, configured to, or operable to support a means for obtaining a report including information indicative of CLI, where the information indicative of the CLI is associated with one or more CLI resources that are within one or more TTIs of the first type of TTI.

Additionally, or alternatively, the communications manager 1420 may support wireless communication at a first network entity (e.g., the device 1405) in accordance with examples as disclosed herein. For example, the communications manager 1420 is capable of, configured to, or operable to support a means for outputting control information that indicates resource allocation information for measuring CLI. The communications manager 1420 is capable of, configured to, or operable to support a means for obtaining a report including information indicative of CLI, where the information indicative of the CLI is associated within one or more CLI resources in accordance with the resource allocation information, and where the one or more CLI resources are within one or more sub-bands of a set of non-contiguous sub-bands allocated for downlink communication.

By including or configuring the communications manager 1420 in accordance with examples as described herein, the device 1405 may support techniques for improved communication reliability, reduced latency, and more efficient utilization of communication resources.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of CLI reporting for multiple types of TTIs as described herein, or the at least one processor 1435 and the at least one memory 1425 may be otherwise configured to, individually or collectively, perform or support such operations.

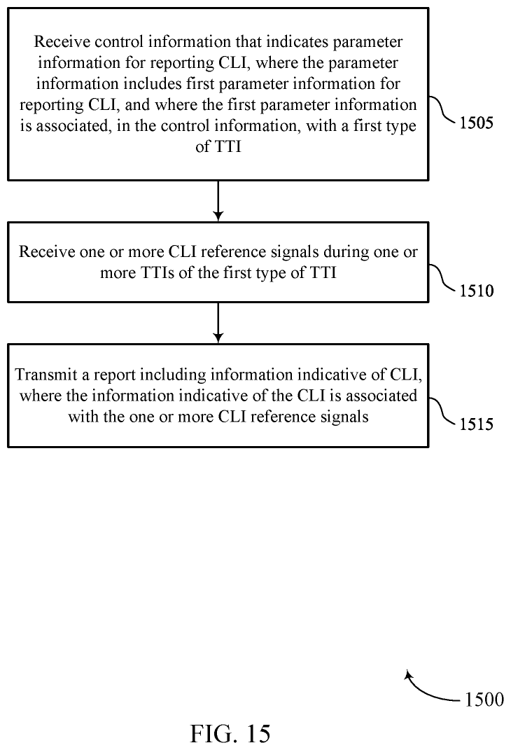

FIG. 15 shows a flowchart illustrating a method 1500 that supports CLI reporting for multiple types of TTIs in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving control information that indicates parameter information for reporting CLI, where the parameter information includes first parameter information for reporting CLI, and where the first parameter information is associated, in the control information, with a first type of TTI. The operations of block 1505 may be performed in accordance with examples as disclosed herein. In some examples, aspects of the operations of 1505 may be performed by a control information component 925 as described with reference to FIG. 9.

At 1510, the method may include receiving one or more CLI reference signals during one or more TTIs of the first type of TTI. The operations of block 1510 may be performed in accordance with examples as disclosed herein. In some examples, aspects of the operations of 1510 may be performed by a CLI reference signal component 930 as described with reference to FIG. 9.

At 1515, the method may include transmitting a report including information indicative of CLI, where the information indicative of the CLI is associated with the one or more CLI reference signals. The operations of block 1515 may be performed in accordance with examples as disclosed herein. In some examples, aspects of the operations of 1515 may be performed by a report component 935 as described with reference to FIG. 9.

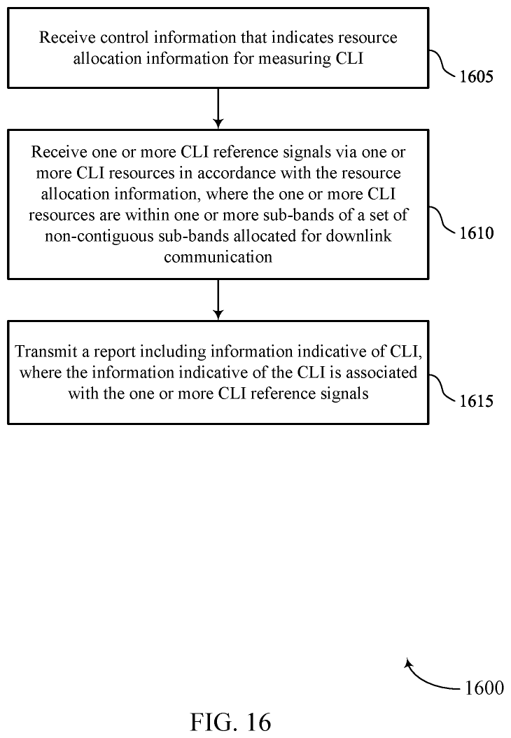

FIG. 16 shows a flowchart illustrating a method 1600 that supports CLI reporting for multiple types of TTIs in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving control information that indicates resource allocation information for measuring CLI. The operations of block 1605 may be performed in accordance with examples as disclosed herein. In some examples, aspects of the operations of 1605 may be performed by a control information component 925 as described with reference to FIG. 9.

At 1610, the method may include receiving one or more CLI reference signals via one or more CLI resources in accordance with the resource allocation information, where the one or more CLI resources are within one or more sub-bands of a set of non-contiguous sub-bands allocated for downlink communication. The operations of block 1610 may be performed in accordance with examples as disclosed herein. In some examples, aspects of the operations of 1610 may be performed by a CLI reference signal component 930 as described with reference to FIG. 9.

At 1615, the method may include transmitting a report including information indicative of CLI, where the information indicative of the CLI is associated with the one or more CLI reference signals. The operations of block 1615 may be performed in accordance with examples as disclosed herein. In some examples, aspects of the operations of 1615 may be performed by a report component 935 as described with reference to FIG. 9.

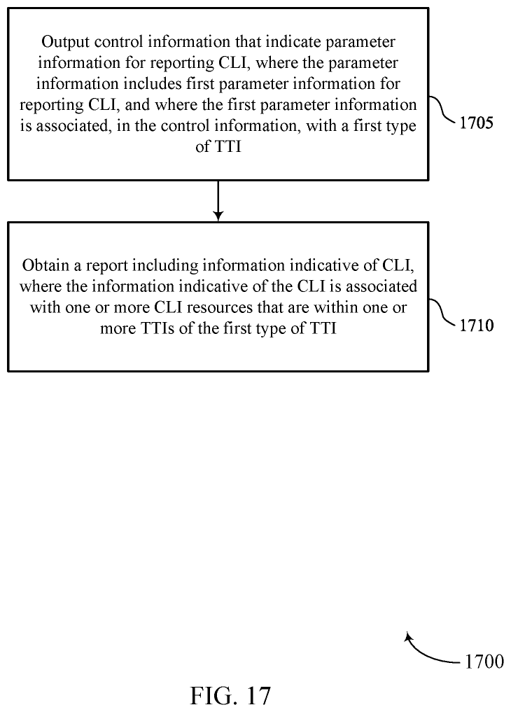

FIG. 17 shows a flowchart illustrating a method 1700 that supports CLI reporting for multiple types of TTIs in accordance with aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include outputting control information that indicates parameter information for reporting CLI, where the parameter information includes first parameter information for reporting CLI, and where the first parameter information is associated, in the control information, with a first type of TTI. The operations of block 1705 may be performed in accordance with examples as disclosed herein. In some examples, aspects of the operations of 1705 may be performed by a parameter information component 1325 as described with reference to FIG. 13.

At 1710, the method may include obtaining a report including information indicative of CLI, where the information indicative of the CLI is associated with one or more CLI resources that are within one or more TTIs of the first type of TTI. The operations of block 1710 may be performed in accordance with examples as disclosed herein. In some examples, aspects of the operations of 1710 may be performed by a CLI indication component 1330 as described with reference to FIG. 13.

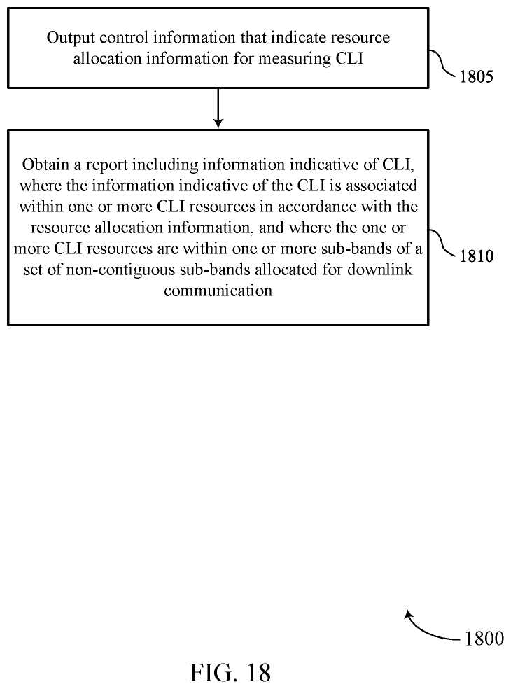

FIG. 18 shows a flowchart illustrating a method 1800 that supports CLI reporting for multiple types of TTIs in accordance with aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting control information that indicates resource allocation information for measuring CLI. The operations of block 1805 may be performed in accordance with examples as disclosed herein. In some examples, aspects of the operations of 1805 may be performed by a resource allocation information component 1335 as described with reference to FIG. 13.

At 1810, the method may include obtaining a report including information indicative of CLI, where the information indicative of the CLI is associated within one or more CLI resources in accordance with the resource allocation information, and where the one or more CLI resources are within one or more sub-bands of a set of non-contiguous sub-bands allocated for downlink communication. The operations of block 1810 may be performed in accordance with examples as disclosed herein. In some examples, aspects of the operations of 1810 may be performed by a CLI indication component 1330 as described with reference to FIG. 13.

The following provides an overview of aspects of the present disclosure:

Aspect 1: A method of wireless communication performed by a first network entity, comprising: receiving control information that indicates parameter information for reporting CLI, wherein the parameter information includes first parameter information for reporting CLI, and wherein the first parameter information is associated, in the control information, with a first type of TTI; receiving one or more CLI reference signals during one or more TTIs of the first type of TTI; and transmitting a report including information indicative of CLI, wherein the information indicative of the CLI is associated with the one or more CLI reference signals.

Aspect 2: The method of aspect 1, wherein the parameter information includes second parameter information for reporting CLI, the second parameter information is associated, in the control information, with a second type of TTI, and the second type of TTI is different from the first type of TTI.

Aspect 3: The method of aspect 2, wherein the control information indicates a first set of CLI resources associated with the first type of TTI and a second set of CLI resources associated with the second type of TTI.

Aspect 4: The method of aspect 3, wherein the one or more CLI reference signals are received during at least one CLI reference signal of the first set of CLI resources.

Aspect 5: The method of any of aspects 2 through 4, wherein the information indicative of the CLI is associated with only the first type of TTI.

Aspect 6: The method of aspect 5, further comprising: receiving a second one or more CLI reference signals during one or more TTIs of the second type of TTI; and transmitting a second report including second information indicative of CLI, wherein the second information indicative of the CLI is associated with only the second one or more CLI reference signals.

Aspect 7: The method of aspect 2, wherein the information indicative of the CLI is associated with both the first type of TTI and the second type of TTI.

Aspect 8: The method of aspect 7, further comprising: refraining from averaging CLI measurement values across different TTI types, wherein the information indicative of the CLI comprises first information associated with the first type of TTI and second information associated with the second type of TTI based on the refraining.

Aspect 9: The method of aspect 8, wherein the first information comprises a first CLI measurement value that is indicated as being associated with the first type of TTI, and the second information comprises a second CLI measurement value that is indicated as being associated with the second type of TTI.

Aspect 10: The method of aspect 9, wherein first CLI measurement value comprises a first value of a CLI metric and the second CLI measurement value comprises a second value of the CLI metric, and the first value is associated with the first type of TTI and the second value is associated with the second type of TTI.

Aspect 11: The method of any of aspects 1 through 10, wherein the first type of TTI comprises a SBFD TTI type, a non-SBFD TTI type, a misaligned dynamic TDD TTI type, an aligned dynamic TDD TTI type, or a non-SBFD misaligned dynamic TDD TTI type.

Aspect 12: The method of any of aspects 1 through 11, further comprising: generating, based on the one or more CLI reference signals, the information indicative of the CLI.

Aspect 13: The method of any of aspects 1 through 12, wherein receiving the control information comprises: receiving the control information via a CLI report configuration message or a CSI report configuration message.

Aspect 14: The method of any of aspects 1 through 13, wherein the control information indicates a minimum quantity of TTIs between a reporting TTI in which the report is to be transmitted and a reference TTI, and the minimum quantity of TTIs includes TTIs of any type.

Aspect 15: The method of any of aspects 1 through 13, wherein the control information indicates a minimum quantity of TTIs between a reporting TTI in which the report is to be transmitted and a reference TTI, the minimum quantity of TTIs includes TTIs of only the first type.

Aspect 16: The method of any of aspects 1 through 15, wherein the first type of TTI comprises a type of slot or a type of symbol.

Aspect 17: The method of any of aspects 1 through 16, wherein the first network entity comprises a UE, the one or more CLI reference signals comprise UE-to-UE CLI reference signals, and the information indicative of CLI comprises information indicative of UE-to-UE CLI.

Aspect 18: The method of any of aspects 1 through 17, wherein the first parameter information is for reporting CLI that is associated with a half-duplex operation mode at the first network entity.

Aspect 19: The method of any of aspects 1 through 17, wherein receiving the control information comprises: receiving the control information from a second network entity, wherein the first parameter information is for reporting CLI that is associated with a full-duplex operation mode at the second network entity.

Aspect 20: The method of any of aspects 1 through 17, wherein receiving the control information comprises: receiving the control information from a second network entity, wherein the first parameter information is for reporting CLI that is associated with a SBFD operation mode at the second network entity.

Aspect 21: The method of any of aspects 1 through 17, wherein receiving the control information comprises: receiving the control information from a second network entity, wherein the first parameter information is for reporting CLI that is associated with a half-duplex operation mode at the second network entity and with a misaligned TTI format.

Aspect 22: The method of any of aspects 1 through 21, wherein the parameter information comprises information indicative of at least one parameter for measuring or reporting CLI.

Aspect 23: The method of aspect 22, wherein the at least one parameter comprises a type of CLI metric to be reported, one or more resources for measuring CLI, or one or more resources for reporting CLI.

Aspect 24: The method of any of aspects 22 through 23, wherein the type of CLI metric comprises an RSRP metric type or an RSSI metric type.

Aspect 25: The method of any of aspects 1 through 24, wherein the control information comprises an indication that the first parameter information is applicable to TTIs of the first type of TTI.

Aspect 26: A method of wireless communication performed by a first network entity, comprising: receiving control information that indicates resource allocation information for measuring CLI; receiving one or more CLI reference signals via one or more CLI resources in accordance with the resource allocation information, wherein the one or more CLI resources are within one or more sub-bands of a set of non-contiguous sub-bands allocated for downlink communication; and transmitting a report including information indicative of CLI, wherein the information indicative of the CLI is associated with the one or more CLI reference signals.

Aspect 27: The method of aspect 26, wherein the one or more CLI resources comprises a CLI resource that is within one sub-band of the set of non-contiguous sub-bands allocated for downlink communication.

Aspect 28: The method of aspect 26, wherein the one or more CLI resources comprises two CLI resources, and each CLI resource of the two CLI resources is within a respective sub-band of the set of non-contiguous sub-bands allocated for downlink communication.

Aspect 29: The method of aspect 26, wherein the one or more CLI resources comprises a CLI resource that is within at least two sub-bands of the set of non-contiguous sub-bands allocated for downlink communication.

Aspect 30: The method of aspect 29, wherein the resource allocation information comprises a bitmap that indicates a distribution of the CLI resource across the set of non-contiguous sub-bands.

Aspect 31: The method of aspect 29, wherein the resource allocation information indicates a plurality of resource block sets that include the CLI resource, and each resource block set of the plurality of resource block sets is associated with a respective sub-band of the set of non-contiguous sub-bands allocated for downlink communication.

Aspect 32: The method of any of aspects 26 through 31, wherein the one or more CLI resources comprise a CLI resource that is within the set of non-contiguous sub-bands allocated for downlink communication, and wherein the method further comprises: measuring CLI within a portion of the CLI resource, wherein the portion is based on semi-static configuration information for SBFD operations, wherein the semi-static configuration information is for a sub-band allocated for uplink communications and one or more sub-bands of the set of non-contiguous sub-bands allocated for downlink communication or the semi-static configuration information is for the sub-band allocated for uplink communications and one or more guard bands, and wherein the information is indicative of the measured CLI.

Aspect 33: The method of aspect 32, further comprising: receiving second control information that indicates a frequency location of the sub-band allocated for uplink communication or a respective frequency location of the one or more guard bands.

Aspect 34: The method of any of aspects 26 through 33, wherein the resource allocation information indicates two CLI resource sets that include the one or more CLI resources, and each CLI resource set of the two CLI resource sets is associated with a respective sub-band of the set of non-contiguous sub-bands allocated for downlink communication.

Aspect 35: The method of any of aspects 26 through 33, wherein the resource allocation information indicates a CLI resource set that includes the one or more CLI resources, and the CLI resource set is associated with the set of non-contiguous sub-bands allocated for downlink communication.

Aspect 36: The method of aspect 35, wherein the resource allocation information comprises a bitmap that indicates the one or more CLI resources.

Aspect 37: The method of aspect 35, wherein the resource allocation information indicates one or more resource block sets within the CLI resource set, the one or more resource block sets include the one or more CLI resources, and each resource block set is associated with a respective sub-band of the set of non-contiguous sub-bands allocated for downlink communication.

Aspect 38: The method of any of aspects 35 through 37, further comprising: measuring CLI within one or more resource block sets within the CLI resource set, wherein the one or more resource block sets include the one or more CLI resources, wherein the one or more resource block sets are based on semi-static configuration information for SBFD operations, wherein the semi-static configuration information is for a sub-band allocated for uplink communications and one or more sub-bands of the set of non-contiguous sub-bands allocated for downlink communication or the semi-static configuration information is for the sub-band allocated for uplink communications and one or more guard bands, and wherein the information is indicative of the measured CLI.

Aspect 39: The method of any of aspects 26 through 38, wherein the set of non-contiguous sub-bands allocated for downlink communication are within a TTI allocated for SBFD operations at a second network entity.

Aspect 40: The method of aspect 39, wherein the first network entity comprises a UE and the second network entity comprises a base station.

Aspect 41: The method of aspect 40, wherein the one or more CLI reference signals comprise UE-to-UE CLI reference signals, and the resource allocation information is for measuring UE-to-UE CLI.

Aspect 42: The method of any of aspects 26 through 41, wherein the resource allocation information is for measuring CLI that is associated with a half-duplex operation mode at the first network entity.

Aspect 43: The method of any of aspects 26 through 41, wherein receiving the control information comprises: receiving the control information from a second network entity, wherein the resource allocation information is for measuring CLI that is associated with a full-duplex operation mode at the second network entity.

Aspect 44: The method of any of aspects 26 through 41, wherein receiving the control information comprises: receiving the control information from a second network entity, wherein the resource allocation information is for measuring CLI that is associated with a SBFD operation mode at the second network entity.

Aspect 45: The method of any of aspects 26 through 41, wherein receiving the control information comprises: receiving the control information from a second network entity, wherein the resource allocation information is for measuring CLI that is associated with a half-duplex operation mode at the second network entity and with a misaligned TTI format.

Aspect 46: A method of wireless communication performed by a first network entity, comprising: outputting control information that indicates parameter information for reporting CLI, wherein the parameter information includes first parameter information for reporting CLI, and wherein the first parameter information is associated, in the control information, with a first type of TTI; and obtaining a report including information indicative of CLI, wherein the information indicative of the CLI is associated with one or more CLI resources that are within one or more TTIs of the first type of TTI.

Aspect 47: The method of aspect 46, wherein the parameter information includes second parameter information for reporting CLI, the second parameter information is associated, in the control information, with a second type of TTI, and the second type of TTI is different from the first type of TTI.

Aspect 48: The method of aspect 47, wherein the control information indicates a first set of CLI resources associated with the first type of TTI and a second set of CLI resources associated with the second type of TTI.

Aspect 49: The method of aspect 48, wherein the first set of CLI resources comprises the one or more CLI resources.

Aspect 50: The method of any of aspects 47 through 49, wherein the information indicative of the CLI is associated with only the first type of TTI.

Aspect 51: The method of aspect 50, further comprising: obtaining a second report including second information indicative of CLI, wherein the second information indicative of the CLI is associated with only a second one or more CLI resources that are within one or more TTIs of the second type of TTI.

Aspect 52: The method of any of aspects 47 through 49, wherein the information indicative of the CLI is associated with both the first type of TTI and the second type of TTI.

Aspect 53: The method of aspect 52, wherein the information indicative of the CLI comprises first information associated with the first type of TTI and second information associated with the second type of TTI.

Aspect 54: The method of aspect 53, wherein the first information comprises a first CLI measurement value that is indicated as being associated with the first type of TTI, and the second information comprises a second CLI measurement value that is indicated as being associated with the second type of TTI.

Aspect 55: The method of aspect 54, wherein first CLI measurement value comprises a first value of a CLI metric and the second CLI measurement value comprises a second value of the CLI metric, and the first value is associated with the first type of TTI and the second value is associated with the second type of TTI.

Aspect 56: The method of any of aspects 46 through 55, wherein the first type of TTI comprises a SBFD TTI type, a non-SBFD TTI type, a misaligned dynamic TDD TTI type, an aligned dynamic TDD TTI type, or a non-SBFD misaligned dynamic TDD TTI type.

Aspect 57: The method of any of aspects 46 through 56, wherein the first type of TTI comprises a type of slot or a type of symbol.

Aspect 58: The method of any of aspects 46 through 57, wherein outputting the control information comprises: outputting the control information via a CLI report configuration message or a CSI report configuration message.

Aspect 59: The method of any of aspects 46 through 58, wherein the control information indicates a minimum quantity of TTIs between a reporting TTI in which the report is to be transmitted and a reference TTI, and the minimum quantity of TTIs includes TTIs of any type.

Aspect 60: The method of any of aspects 46 through 58, wherein the control information indicates a minimum quantity of TTIs between a reporting TTI in which the report is to be transmitted and a reference TTI, the minimum quantity of TTIs includes TTIs of only the first type.

Aspect 61: The method of any of aspects 46 through 60, wherein the first type of TTI comprises a type of slot or a type of symbol.

Aspect 62: The method of any of aspects 46 through 61, wherein the information indicative of CLI comprises information indicative of UE-to-UE CLI.

Aspect 63: The method of any of aspects 46 through 62, wherein outputting the control information comprises: outputting the control information to a second network entity, wherein the first parameter information is for reporting CLI that is associated with a half-duplex operation mode at the second network entity.

Aspect 64: The method of any of aspects 46 through 62, wherein the first parameter information is for reporting CLI that is associated with a full-duplex operation mode at the first network entity.

Aspect 65: The method of any of aspects 46 through 62, wherein the first parameter information is for reporting CLI that is associated with a SBFD operation mode at the first network entity.

Aspect 66: The method of any of aspects 46 through 62, wherein the first parameter information is for reporting CLI that is associated with a half-duplex operation mode at the first network entity and with a misaligned TTI format.

Aspect 67: The method of any of aspects 46 through 66, wherein outputting the control information comprises: outputting the control information to a second network entity, wherein the first parameter information is indicative of at least one parameter for measuring or reporting CLI.

Aspect 68: The method of aspect 67, wherein the at least one parameter comprises a type of CLI metric to be reported, one or more resources for measuring CLI, or one or more resources for reporting CLI.

Aspect 69: The method of any of aspects 67 through 68, wherein the type of CLI metric comprises a RSRP metric type or a RSSI metric type.

Aspect 70: The method of any of aspects 46 through 69, wherein the control information comprises an indication that the first parameter information is applicable to TTIs of the first type of TTI.

Aspect 71: A method of wireless communication performed by a first network entity, comprising: outputting control information that indicates resource allocation information for measuring CLI; and obtaining a report including information indicative of CLI, wherein the information indicative of the CLI is associated within one or more CLI resources in accordance with the resource allocation information, and wherein the one or more CLI resources are within one or more sub-bands of a set of non-contiguous sub-bands allocated for downlink communication.

Aspect 72: The method of aspect 71, wherein the one or more CLI resources comprises a CLI resource that is within one sub-band of the set of non-contiguous sub-bands allocated for downlink communication.

Aspect 73: The method of aspect 71, wherein the one or more CLI resources comprises two CLI resources, and each CLI resource of the two CLI resources is within a respective sub-band of the set of non-contiguous sub-bands allocated for downlink communication.

Aspect 74: The method of aspect 71, wherein the one or more CLI resources comprises a CLI resource that is within at least two sub-bands of the set of non-contiguous sub-bands allocated for downlink communication.

Aspect 75: The method of aspect 74, wherein the resource allocation information comprises a bitmap that indicates a distribution of the CLI resource across the set of non-contiguous sub-bands.

Aspect 76: The method of aspect 74, wherein the resource allocation information indicates a plurality of resource block sets that include the CLI resource, and each resource block set of the plurality of resource block sets is associated with a respective sub-band of the set of non-contiguous sub-bands allocated for downlink communication.

Aspect 77: The method of any of aspects 71 through 76, wherein the one or more CLI resources comprise a CLI resource that is within the set of non-contiguous sub-bands allocated for downlink communication, and the information is indicative of CLI measured within a portion of the CLI resource that is based on semi-static configuration information for SBFD operations, the semi-static configuration information is for a sub-band allocated for uplink communications and one or more sub-bands of the set of non-contiguous sub-bands allocated for downlink communication or the semi-static configuration information is for the sub-band allocated for uplink communications and one or more guard bands.

Aspect 78: The method of aspect 77, further comprising: outputting second control information that indicates a frequency location of the sub-band allocated for uplink communication or a respective frequency location of the one or more guard bands.

Aspect 79: The method of any of aspects 71 through 78, wherein the resource allocation information indicates two CLI resource sets that include the one or more CLI resources, and each CLI resource set of the two CLI resource sets is associated with a respective sub-band of the set of non-contiguous sub-bands allocated for downlink communication.

Aspect 80: The method of any of aspects 71 through 78, wherein the resource allocation information indicates a CLI resource set that includes the one or more CLI resources, and the CLI resource set is associated with the set of non-contiguous sub-bands allocated for downlink communication.

Aspect 81: The method of aspect 80, wherein the resource allocation information comprises a bitmap that indicates the one or more CLI resources.

Aspect 82: The method of aspect 80, wherein the resource allocation information indicates one or more resource block sets within the CLI resource set, the one or more resource block sets include the one or more CLI resources, and each resource block set is associated with a respective sub-band of the set of non-contiguous sub-bands allocated for downlink communication.

Aspect 83: The method of any of aspects 80 through 82, wherein the information is indicative of CLI measured within one or more resource block sets within the CLI resource set, the one or more resource block sets include the one or more CLI resources, and the one or more resource block sets are based on semi-static configuration information for SBFD operations, the semi-static configuration information is for a sub-band allocated for uplink communications and one or more sub-bands of the set of non-contiguous sub-bands allocated for downlink communication or the semi-static configuration information is for the sub-band allocated for uplink communications and one or more guard bands.

Aspect 84: The method of any of aspects 71 through 83, wherein the set of non-contiguous sub-bands allocated for downlink communication are within a TTI allocated for SBFD operations at the first network entity.

Aspect 85: The method of any of aspects 71 through 84, wherein the first network entity comprises a base station.

Aspect 86: The method of any of aspects 71 through 85, wherein outputting the control information comprises: outputting the control information to a second network entity that comprises a UE, wherein the resource allocation information is for measuring UE-to-UE CLI.

Aspect 87: The method of any of aspects 71 through 86, wherein outputting the control information comprises: outputting the control information to a second network entity, wherein the resource allocation information is for measuring CLI that is associated with a half-duplex operation mode at the second network entity.

Aspect 88: The method of any of aspects 71 through 86, wherein the resource allocation information is for measuring CLI that is associated with a full-duplex operation mode at the first network entity.

Aspect 89: The method of any of aspects 71 through 86, wherein the resource allocation information is for measuring CLI that is associated with a SBFD operation mode at the first network entity.

Aspect 90: The method of any of aspects 71 through 86, wherein the resource allocation information is for measuring CLI that is associated with a half-duplex operation mode at the first network entity and with a misaligned TTI format.

Aspect 91: A first network entity for wireless communication, comprising at least one communication interface; and at least one processor coupled to the at least one communication interface, wherein the first network entity is configured to perform a method of any of aspects 1 through 25.

Aspect 92: A first network entity for wireless communication, comprising at least one means for performing a method of any of aspects 1 through 25.

Aspect 93: A non-transitory computer-readable medium having code for wireless communication stored thereon that, when executed by a first network entity, causes the first network entity to perform a method of any of aspects 1 through 25.

Aspect 94: A first network entity for wireless communication, comprising at least one communication interface; and at least one processor coupled to the at least one communication interface, wherein the first network entity is configured to perform a method of any of aspects 26 through 45.

Aspect 95: A first network entity for wireless communication, comprising at least one means for performing a method of any of aspects 26 through 45.

Aspect 96: A non-transitory computer-readable medium having code for wireless communication stored thereon that, when executed by a first network entity, causes the first network entity to perform a method of any of aspects 26 through 45.

Aspect 97: A first network entity for wireless communication, comprising at least one communication interface; and at least one processor coupled to the at least one communication interface, wherein the first network entity is configured to perform a method of any of aspects 46 through 70.

Aspect 98: A first network entity for wireless communication, comprising at least one means for performing a method of any of aspects 46 through 70.

Aspect 99: A non-transitory computer-readable medium having code for wireless communication stored thereon that, when executed by a first network entity, causes the first network entity to perform a method of any of aspects 46 through 70.

Aspect 100: A first network entity for wireless communication, comprising at least one communication interface; and at least one processor coupled to the at least one communication interface, wherein the first network entity is configured to perform a method of any of aspects 71 through 90.

Aspect 101: A first network entity for wireless communication, comprising at least one means for performing a method of any of aspects 71 through 90.

Aspect 102: A non-transitory computer-readable medium having code for wireless communication stored thereon that, when executed by a first network entity, causes the first network entity to perform a method of any of aspects 71 through 90.

The methods described herein describe possible implementations, and the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity for wireless communication, comprising:
at least one communication interface; and
at least one processor coupled to the at least one communication interface, wherein the first network entity is configured to:
receive control information that indicates parameter information for reporting cross-link interference, wherein the parameter information includes first parameter information for reporting cross-link interference, and wherein the first parameter information is associated, in the control information, with a first type of transmission time interval;
receive one or more cross-link interference reference signals during one or more transmission time intervals of the first type of transmission time interval; and
transmit a report including information indicative of cross-link interference, wherein the information indicative of the cross-link interference is associated with the one or more cross-link interference reference signals.

2. The first network entity of claim 1, wherein the parameter information includes second parameter information for reporting cross-link interference, wherein the second parameter information is associated, in the control information, with a second type of transmission time interval, and wherein the second type of transmission time interval is different from the first type of transmission time interval.

3. The first network entity of claim 2, wherein the control information indicates a first set of cross-link interference resources associated with the first type of transmission time interval and a second set of cross-link interference resources associated with the second type of transmission time interval.

4. The first network entity of claim 3, wherein the one or more cross-link interference reference signals are received during at least one cross-link interference reference signal of the first set of cross-link interference resources.

5. The first network entity of claim 2, wherein the information indicative of the cross-link interference is associated with only the first type of transmission time interval.

6. The first network entity of claim 5, wherein the first network entity is configured to:
receive a second one or more cross-link interference reference signals during one or more transmission time intervals of the second type of transmission time interval; and
transmit a second report including second information indicative of cross-link interference, wherein the second information indicative of the cross-link interference is associated with only the second one or more cross-link interference reference signals.

7. The first network entity of claim 2, wherein the information indicative of the cross-link interference is associated with both the first type of transmission time interval and the second type of transmission time interval.

8. The first network entity of claim 7, wherein the first network entity is configured to:
refrain from averaging cross-link interference measurement values across different transmission time interval types, and wherein the information indicative of the cross-link interference comprises first information associated with the first type of transmission time interval and second information associated with the second type of transmission time interval based on the refraining.

9. The first network entity of claim 8, wherein the first information comprises a first cross-link interference measurement value that is indicated as being associated with the first type of transmission time interval, and wherein the second information comprises a second cross-link interference measurement value that is indicated as being associated with the second type of transmission time interval.

10. The first network entity of claim 9, wherein first cross-link interference measurement value comprises a first value of a cross-link interference metric and the second cross-link interference measurement value comprises a second value of the cross-link interference metric, and wherein the first value is associated with the first type of transmission time interval and the second value is associated with the second type of transmission time interval.

11. The first network entity of claim 1, wherein the first type of transmission time interval comprises a sub-band full-duplex transmission time interval type, a non-sub-band full-duplex transmission time interval type, a misaligned dynamic time division duplex transmission time interval type, an aligned dynamic time division duplex transmission time interval type, or a non-sub-band full-duplex misaligned dynamic time division duplex transmission time interval type.

12. The first network entity of claim 1, wherein the first network entity is configured to:
generate, based on the one or more cross-link interference reference signals, the information indicative of the cross-link interference.

13. The first network entity of claim 1, wherein, to receive the control information, the first network entity is configured to:
receive the control information via a cross-link interference report configuration message or a channel state information report configuration message.

14. The first network entity of claim 1, wherein the control information indicates a minimum quantity of transmission time intervals between a reporting transmission time interval in which the report is to be transmitted and a reference transmission time interval, and wherein the minimum quantity of transmission time intervals includes transmission time intervals of any type.

15. The first network entity of claim 1, wherein the control information indicates a minimum quantity of transmission time intervals between a reporting transmission time interval in which the report is to be transmitted and a reference transmission time interval, wherein the minimum quantity of transmission time intervals includes transmission time intervals of only the first type.

16. The first network entity of claim 1, wherein the first type of transmission time interval comprises a type of slot or a type of symbol.

17. The first network entity of claim 1, wherein the first network entity comprises a user equipment (UE), wherein the one or more cross-link interference reference signals comprise UE-to-UE cross-link interference reference signals, and wherein the information indicative of cross-link interference comprises information indicative of UE-to-UE cross-link interference.

18. The first network entity of claim 1, wherein the first parameter information is for reporting cross-link interference that is associated with a half-duplex operation mode at the first network entity.

19. The first network entity of claim 1, wherein, to receive the control information, the first network entity is configured to receive the control information from a second network entity, and wherein the first parameter information is for reporting cross-link interference that is associated with a full-duplex operation mode at the second network entity.

20. The first network entity of claim 1, wherein, to receive the control information, the first network entity is configured to receive the control information from a second network entity, and wherein the first parameter information is for reporting cross-link interference that is associated with a sub-band full-duplex operation mode at the second network entity.

21. The first network entity of claim 1, wherein, to receive the control information, the first network entity is configured to receive the control information from a second network entity, and wherein the first parameter information is for reporting cross-link interference that is associated with a half-duplex operation mode at the second network entity and with a misaligned transmission time interval format.

22. The first network entity of claim 1, wherein the parameter information comprises information indicative of at least one parameter for measuring or reporting cross-link interference.

23. The first network entity of claim 22, wherein the at least one parameter comprises a type of cross-link interference metric to be reported, one or more resources for measuring cross-link interference, or one or more resources for reporting cross-link interference.

24. The first network entity of claim 22, wherein the type of cross-link interference metric comprises a reference signal received power metric type or a received signal strength indicator metric type.

25. The first network entity of claim 1, wherein the control information comprises an indication that the first parameter information is applicable to transmission time intervals of the first type of transmission time interval.

26. A first network entity for wireless communication, comprising:
at least one communication interface; and
at least one processor coupled to the at least one communication interface, wherein the first network entity is configured to:
receive control information that indicates resource allocation information for measuring cross-link interference;
receive one or more cross-link interference reference signals via one or more cross-link interference resources in accordance with the resource allocation information, wherein the one or more cross-link interference resources are within one or more sub-bands of a set of non-contiguous sub-bands allocated for downlink communication; and
transmit a report including information indicative of cross-link interference, wherein the information indicative of the cross-link interference is associated with the one or more cross-link interference reference signals.

27. The first network entity of claim 26, wherein the one or more cross-link interference resources comprises a cross-link interference resource that is within one sub-band of the set of non-contiguous sub-bands allocated for downlink communication.

28. The first network entity of claim 26, wherein the one or more cross-link interference resources comprises two cross-link interference resources, and wherein each cross-link interference resource of the two cross-link interference resources is within a respective sub-band of the set of non-contiguous sub-bands allocated for downlink communication.

29. The first network entity of claim 26, wherein the one or more cross-link interference resources comprises a cross-link interference resource that is within at least two sub-bands of the set of non-contiguous sub-bands allocated for downlink communication.

30. The first network entity of claim 29, wherein the resource allocation information comprises a bitmap that indicates a distribution of the cross-link interference resource across the set of non-contiguous sub-bands.

31. The first network entity of claim 29, wherein the resource allocation information indicates a plurality of resource block sets that include the cross-link interference resource, and wherein each resource block set of the plurality of resource block sets is associated with a respective sub-band of the set of non-contiguous sub-bands allocated for downlink communication.

32. The first network entity of claim 26, wherein the one or more cross-link interference resources comprise a cross-link interference resource that is within the set of non-contiguous sub-bands allocated for downlink communication, and wherein the first network entity is configured to:
measure cross-link interference within a portion of the cross-link interference resource, wherein the portion is based on semi-static configuration information for sub-band full-duplex operations, wherein the semi-static configuration information is for a sub-band allocated for uplink communications and one or more sub-bands of the set of non-contiguous sub-bands allocated for downlink communication or the semi-static configuration information is for the sub-band allocated for uplink communications and one or more guard bands, and wherein the information is indicative of the measured cross-link interference.

33. The first network entity of claim 32, wherein the first network entity is configured to:
receive second control information that indicates a frequency location of the sub-band allocated for uplink communication or a respective frequency location of the one or more guard bands.

34. The first network entity of claim 26, wherein the resource allocation information indicates two cross-link interference resource sets that include the one or more cross-link interference resources, and wherein each cross-link interference resource set of the two cross-link interference resource sets is associated with a respective sub-band of the set of non-contiguous sub-bands allocated for downlink communication.

35. The first network entity of claim 26, wherein the resource allocation information indicates a cross-link interference resource set that includes the one or more cross-link interference resources, and wherein the cross-link interference resource set is associated with the set of non-contiguous sub-bands allocated for downlink communication.

36. The first network entity of claim 35, wherein the resource allocation information comprises a bitmap that indicates the one or more cross-link interference resources.

37. The first network entity of claim 35, wherein the resource allocation information indicates one or more resource block sets within the cross-link interference resource set, wherein the one or more resource block sets include the one or more cross-link interference resources, and wherein each resource block set is associated with a respective sub-band of the set of non-contiguous sub-bands allocated for downlink communication.

38. The first network entity of claim 35, wherein the first network entity is configured to:
measure cross-link interference within one or more resource block sets within the cross-link interference resource set, wherein the one or more resource block sets include the one or more cross-link interference resources, wherein the one or more resource block sets are based on semi-static configuration information for sub-band full-duplex operations, wherein the semi-static configuration information is for a sub-band allocated for uplink communications and one or more sub-bands of the set of non-contiguous sub-bands allocated for downlink communication or the semi-static configuration information is for the sub-band allocated for uplink communications and one or more guard bands, and wherein the information is indicative of the measured cross-link interference.

39. The first network entity of claim 26, wherein the set of non-contiguous sub-bands allocated for downlink communication are within a transmission time interval allocated for sub-band full-duplex operations at a second network entity.

40. The first network entity of claim 39, wherein the first network entity comprises a user equipment (UE) and the second network entity comprises a base station.

41. The first network entity of claim 40, wherein the one or more cross-link interference reference signals comprise UE-to-UE cross-link interference reference signals, and wherein the resource allocation information is for measuring UE-to-UE cross-link interference.

42. The first network entity of claim 26, wherein the resource allocation information is for measuring cross-link interference that is associated with a half-duplex operation mode at the first network entity.

43. The first network entity of claim 26, wherein, to receive the control information, the first network entity is configured to receive the control information from a second network entity, and wherein the resource allocation information is for measuring cross-link interference that is associated with a full-duplex operation mode at the second network entity.

44. The first network entity of claim 26, wherein, to receive the control information, the first network entity is configured to receive the control information from a second network entity, and wherein the resource allocation information is for measuring cross-link interference that is associated with a sub-band full-duplex operation mode at the second network entity.

45. The first network entity of claim 26, wherein, to receive the control information, the first network entity is configured to receive the control information from a second network entity, and wherein the resource allocation information is for measuring cross-link interference that is associated with a half-duplex operation mode at the second network entity and with a misaligned transmission time interval format.
